(19) United States
(12) Patent Application Publication
(10) Pub. No.: US 2018/0150234 A1
(43) Pub. Date: May 31, 2018

(54) CLOUD VOLUME STORAGE

(71) Applicant: HEWLETT PACKARD ENTERPRISE DEVELOPMENT LP, Houston, TX (US)

(72) Inventors: Sandeep KARMARKAR, San Jose, CA (US); Senthil Kumar Ramamoorthy, Sunnyvale, CA (US); Ajay Singh, Palo Alto, CA (US)

(73) Assignee: HEWLETT PACKARD ENTERPRISE DEVELOPMENT LP, Houston, TX (US)

(21) Appl. No.: 15/821,656

(22) Filed: Nov. 22, 2017

Related U.S. Application Data
(60) Provisional application No. 62/427,116, filed on Nov. 28, 2016.

(51) Int. Cl. G06F 3/06; H04L 29/08

(52) U.S. Cl. CPC G06F 3/067; G06F 3/0629; G06F 3/0665; H04L 67/1097

(57) ABSTRACT

According to examples, a data storage system may include a plurality of storage arrays of a cloud volume provider (CVP), in which the plurality of storage arrays is a plurality of logical volumes. The data storage system may also include a CVP portal to link a first compute instance of a first cloud service provider (CSP) with a first logical volume over a network. A first application executing on the first compute instance may access the first logical volume for storage and the first CSP may provide at least one compute instance for a corresponding entity.

### CLAIM FOR PRIORITY

This application claims priority to U.S. Provisional Patent Application No. 62/427,116, “Cloud Volume Storage,” filed Nov. 28, 2016, the disclosure of which is hereby incorporated by reference in its entirety.

### BACKGROUND

Cloud service providers allow for on-demand use of a shared pool of hardware and software computing resources, such as compute processors, servers, storage, applications, etc. Cloud service providers typically provide services for remote users, which include access to customized computing power to run applications and serve data to numerous remote users. The cloud infrastructure therefore includes server systems, which are typically virtualized. The infrastructure of the cloud service provider allows for customer access to computing resources over a network without necessarily having to manage or own any of the resources. In that manner, the customer pushes the management and ownership of the architecture to the cloud service provider, and instead is able to focus on their day to day business operations. The customer needs only to store and process their data using the computing resources offered by the cloud service provider.

### BRIEF DESCRIPTION OF THE DRAWINGS

The present disclosure will be readily understood by the following detailed description in conjunction with the accompanying drawings, in which like reference numerals designate like structural elements.

FIG. 1A illustrates an example system including a cloud volume provider offering cloud storage for use by a cloud compute instance of a cloud service provider.

FIG. 1B illustrates an example cloud volume provider offering configurable logical volumes of storage, in which a cloud compute instance of a cloud service provider is linked to a specific volume within the storage arrays of the cloud volume provider.

FIG. 1C illustrates an example system including a cloud volume provider offering cloud storage for use by one or more compute instances across multiple cloud service providers, in which the compute instances are operated by a single entity.

FIG. 2 illustrates an example cloud service provider offering processing and data services to clients.

FIG. 3A illustrates an example system including a cloud volume provider offering cloud storage for use by one or more compute instances of a cloud service provider and a portal configured to link logical volumes to compute instances, and more specifically showing exemplary locations of the portal.

FIG. 3B illustrates an example operation of a portal to link a specific volume within a storage array of a cloud volume provider to a cloud compute instance of a cloud service provider.

FIG. 3C illustrates example communication paths for customers accessing logical volumes in a cloud volume provider.

FIG. 4A illustrates an example data center, in which a cloud volume provider may implement operations of the cloud volume provider within the data center.

FIG. 4B illustrates example communication paths between one or more cloud service providers and a cloud volume provider in a data center.

FIG. 5A illustrates an example communication path between a compute instance of a cloud service provider to a specific volume within a storage array of a cloud volume provider in a data center.

FIG. 5B illustrates example communication paths between a plurality of compute instances of a plurality of service provider accessing volumes within one or more storage arrays of a cloud volume provider in a data center, in which the compute instances may be associated with one or more entities.

FIG. 5C illustrates example communication paths between a plurality of compute instances of a plurality of service providers accessing a single volume within a storage array of a cloud volume provider in a data center, in which the compute instances may be associated with one or more entities.

FIG. 5D illustrates an example cloud volume provider offering configurable logical volumes of storage, in which a cloud compute instance of a cloud service provider is linked to a specific object stored within a logical volume.

FIG. 6A illustrates an example cloud volume provider offering configurable logical volumes of storage, in which a cloud compute instance of a cloud service provider is linked to a specific volume within the storage arrays of the cloud volume provider, and in which the cloud volume provider is configurable to access a specific volume using one or more controllers, each of which may be configured with different performance capabilities.

FIG. 6B illustrates example communication paths between compute instances of a plurality of customers operating within one or more cloud service providers, in which communication paths within a data center are isolated between customers such that each customer is associated with its own virtual local area network used for accessing corresponding logical volumes of the corresponding customer.

FIG. 6C illustrates an example system including a cloud volume provider offering cloud storage for use by a private server, thereby implementing a private storage and private compute architecture.

FIG. 7 illustrates an architecture of an example storage array of a cloud volume provider in a data center.

FIG. 8 illustrates read and write paths within the example storage array.

FIG. 9 illustrates example segmentation and compression of write data blocks before saving in hard disk.

FIG. 10 illustrates an example cloud storage system which utilizes cloud storage processing to enable third party storage solutions for compute instances running on cloud service providers, and the use of data analytics to provide predictive information useful to entities operating the compute instances.

### DETAILED DESCRIPTION

Customers of cloud service providers are often able to scale up the use of computing resources according to the customers' demands. For example, computing resources may be managed in real time according to the demand. As such, computing resources may be scaled up as customer needs increase to accommodate for real time demand (e.g., demand between on-peak and off-peak hours) as well as growth of the customer. Further, computing resources may be scaled down as necessary as their demand decreases. However, because the cloud service provider owns and manages the computing resources, customers have limited control over how those computing resources operate. The cloud service provider guarantees a certain level of performance and reliability, but behind those guarantees the customers have no knowledge of how the infrastructure operates to ensure satisfaction of those performance and reliability guarantees. For example, the cloud service provider may offer storage according to customer demand, such as an amount of storage. There is a certain level of reliability that may minimally meet most demands of customers. That is, the storage capabilities offered by the cloud service provider may basically be the same for all customers, and may include guaranteeing an amount of storage with minimal reliability.

However, for customers that demand higher levels of storage performance, the cloud service provider may be unable to meet those requirements. Because the storage operations are implemented to provide basic storage capabilities for all customers of the cloud service provider, any one customer may be unable to demand greater reliability and storage services. This may lead to inefficient storage utilization for a customer requiring greater levels of storage performance. That is, inefficient storage utilization provided by the cloud service provider to accommodate the storage needs of most customers may not be acceptable for a customer requiring higher levels of storage performance. This inefficient storage utilization for a particular customer may lead to a deterioration in data access performance, delays in process, as well as inefficient use of storage on a per-transaction cost of using the selected storage types offered by the cloud service provider.

Further, because the cloud service provider may offer only basic storage capabilities, the customer may not demand implementation of advanced storage capabilities from the cloud service provider. As such, a customer desiring to address the aforementioned storage inefficiencies may be unable to request from the cloud service provider implementation of advanced storage features.

The following disclosure describes methods, systems, and computer programs for providing cloud volumes of storage for compute instances of one or more cloud service providers (CSPs). The CSP may operate one or more datacenters, and the datacenters may be used to service customers that install and operate applications. The applications, running on the infrastructure of the cloud service provider, may typically be referred to as cloud applications or cloud-based applications. These cloud applications may require different amounts of storage and/or different types of storage, depending upon the function of the applications, demands, client loads, stress requirements, and/or storage capacity. The cloud volume provider (CVP) also operates one or more storage arrays that are to assign one or more volumes of storage to one or more compute nodes of one or more CSPs. A CVP portal may link a compute instance to an existing or new logical volume of storage in a storage array of the CVP. The volume may be configurable in at least size and performance (e.g., inputs/outputs per second—IOPS). Further, the volume may be reconfigured to change its sizing according to demand. Also, a customer may use the CVP portal to link multiple compute instances running on multiple CSPs to volumes of one or more storage arrays of the CVP. In addition, data analytics may be performed based on the IO performance of the CVP for a particular customer to gain insight into the operations of both the volumes within the CVP and the compute instances running on corresponding CSPs. Moreover, the infrastructure implementing the cloud volume storage may be extendable to data objects (e.g., folders, files, objects, etc.) other than volumes, in which a data object may be used for organizing or identifying data, such that the cloud instances may access the storage arrays holding the data objects.

With this overview in mind, the following diagrams provide several example implementations of a storage application, provided to optimize the utilization of storage resources provided by a cloud storage provider.

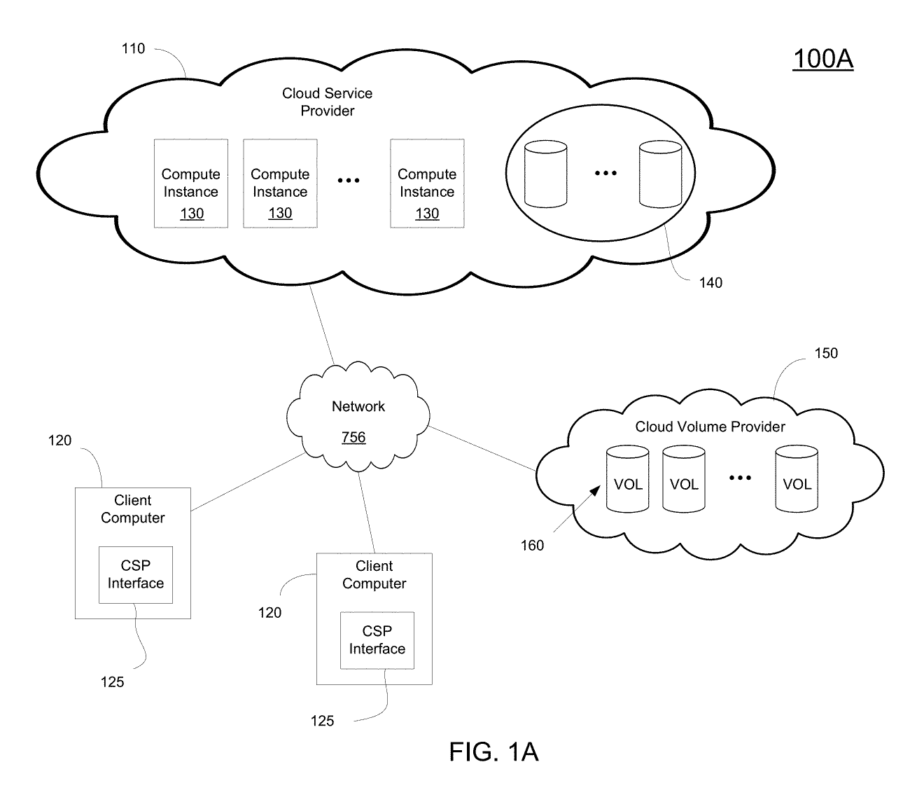

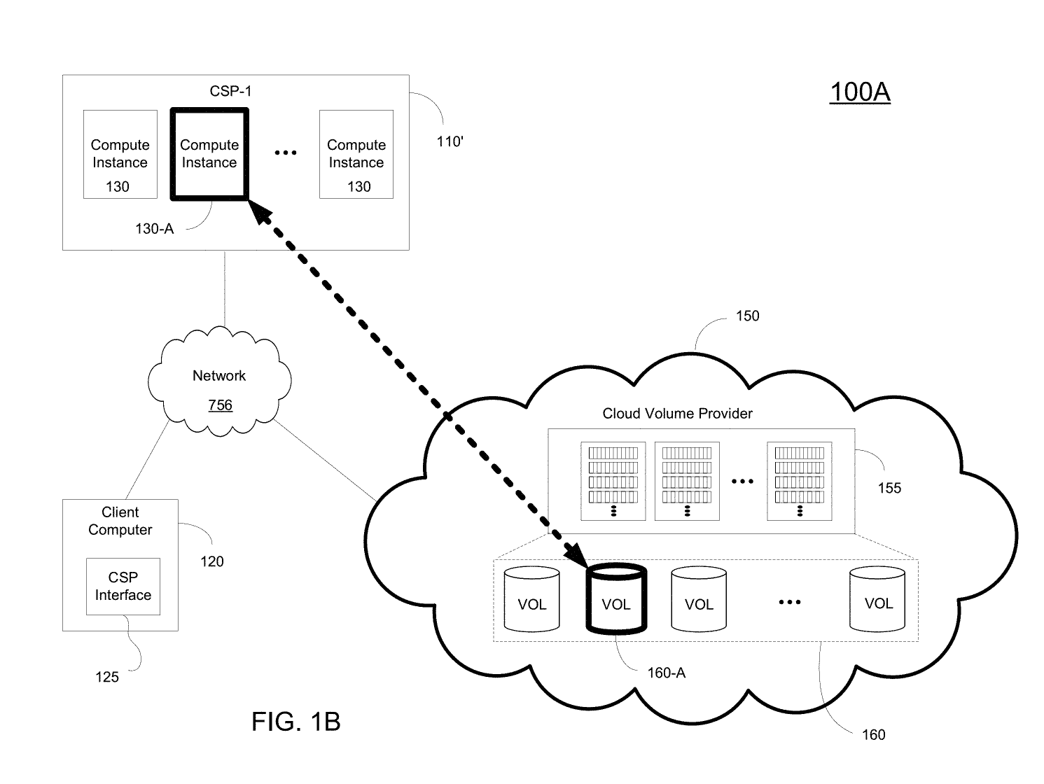

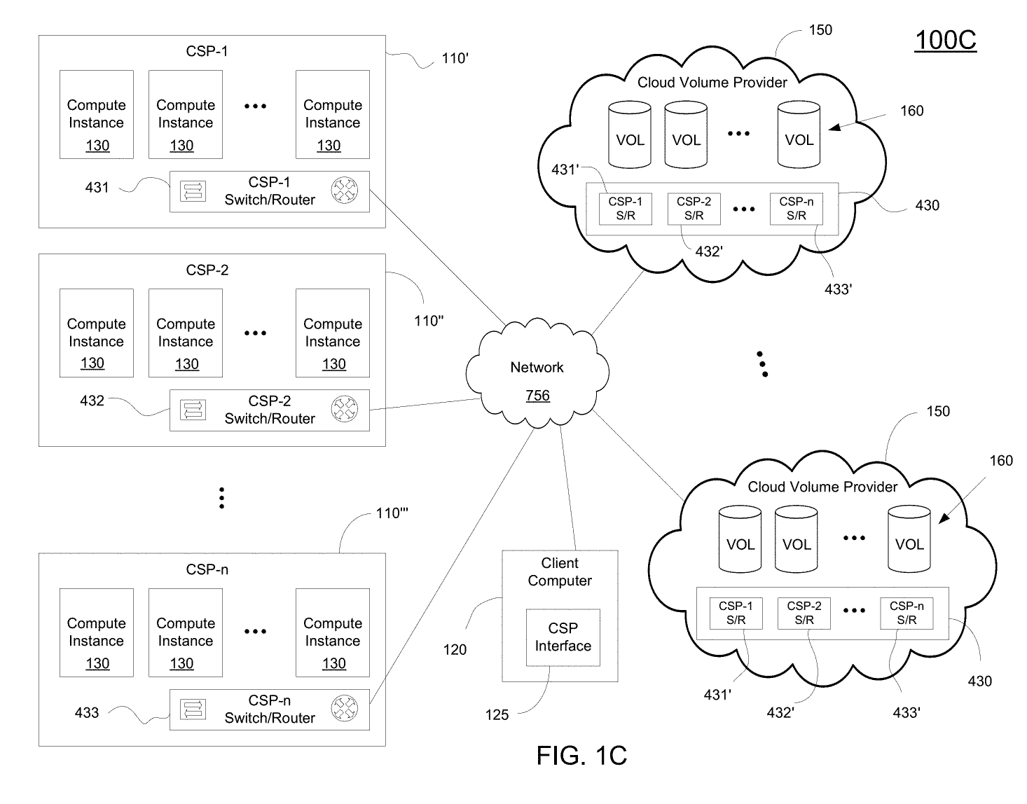

FIG. 1A illustrates an example system 100A including a cloud volume provider 150 offering cloud storage for use by a cloud compute instance of a cloud service provider (CSP) 110. The system 100A may provide cloud storage provided by a third party other than the CSP 110. The storage infrastructure and capabilities may be visible to the customer, so that the customer may selectively take advantage of higher levels of storage capabilities, including advanced features that the CSP 110 may not provide.

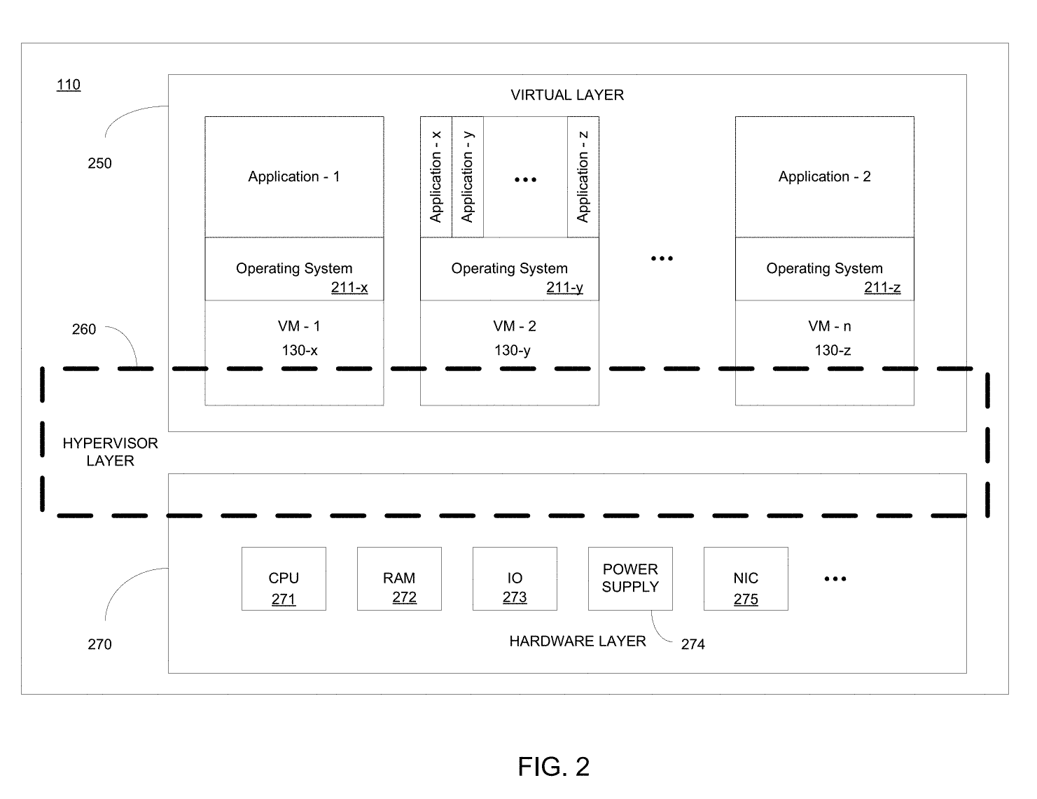

As shown, the system 100A may include the CSP 110 that may offer virtualized cloud computing resources to one or more consumers over a network 756. As an illustration, Amazon Web Services (AWS), Google Cloud Platform or GCE/GCS, by Google, Inc., Microsoft cloud or Azure, by Microsoft Inc., etc. provide services provided by cloud computing. More particularly, the CSP 110 may include one or more virtualized compute instances 130 operating within a virtualization layer. As such, the compute instances may include hardware resources (e.g., processing, memory, etc.) and software resources (e.g., operating systems) provided by the CSP 110 as needed in order to process data. The compute instances may be virtualized as the computing instances may not be assigned dedicated hardware resources, but may be configured with available hardware resources at the instantiation of the corresponding compute instances. The compute instances may be instantiated and/or accessed by one or more entities associated with the one or more client computers 120 through a communication network 756 (e.g., the Internet). Each client computer 120 may include a CSP interface 125 to access and operate a corresponding compute instance 130. A more detailed discussion of the CSP 110 is provided in relation to FIG. 2.

The CSP 110 may also include a storage 140 that may be maintained and operated for customer use. The storage 140 may be implemented within a data center at the direction and control of the CSP 110. For example, the data center may be used solely for purposes of storage for the benefit of the CSP 110. That is, the storage 140 may be considered part of the hardware computing resources provided by the CSP 110.

However, examples of the present invention may provide for implementation of a third party cloud volume provider that may provide storage over a network instead of using the storage 140 associated with the CSP 110. In particular, the cloud volume provider 150 may include a plurality of logical cloud volumes 160 supported by one or more physical storage arrays located at one or more commercial data centers. The CVP 150 may offer cloud volume storage (volume as a service) for cloud connected entities or users. After configuration, a compute instance may interface and store data at corresponding volumes of the CVP 150 instead of the storage 140 offered by the CSP 110. In that manner, an entity may take advantage of data storage services provided by the CVP 150 that may be distinct over the data storage services that the CSP 110 may provide. For example, the CVP 150 may be configured for advanced storage features including data duplication, data replication, snapshots of data, cloning, encryption, shredding, backup, etc., to enhance storage performance. As an illustration, the CVP 150 may provide backup copies across multiple sites at greater frequencies using volume replication for greater reliability than that provided by the CSP 110. The CVP 150 may also be configurable to allow an entity to move and/or migrate data across multiple CSPs, and as such may avoid data lock-in to a specific data storage system of a particular CSP 110.

In some examples, the CSP 110 may be considered to be an entity providing computing resources for customers. However, it should be understood that a CSP as referred to throughout the specification may provide an infrastructure including one or more resources (e.g., software, hardware, etc.) in order to generate one or more compute instances for access to one or more assigned entities (e.g., customers, etc.) over a network (e.g., the Internet), in examples. The CSP 110 may be in one or more private or commercial data centers, all of which may provide computing support resources. As such, the compute instances may execute one or more applications for use by the accessing entities.

FIG. 1B illustrates the example system 110A first introduced in FIG. 1A including a cloud volume provider 150 offering configurable logical volumes of storage. Specifically, the CVP 150 may include one or more physical storage arrays 155 that may be configured as a plurality of logical volumes 160. As previously introduced, the CVP 150 may provide third party storage to compute instances of cloud service providers. For example, the CVP 150 may provide cloud storage to an entity operating a compute instance 130-A using a corresponding client computer 120, in which communication between the client computer 120 and the cloud based computer instance 130-A is implemented over the network 756.

The CVP 150 may be implemented and/or distributed in one or more commercial data centers that are connected to one or more CSPs over high speed network links. For example, the CVP 150 may include one or more storage arrays in the data center, in which the storage array may further be configured as logical volumes. In that manner, an entity implementing cloud volume storage may not need to maintain and/or manage storage hardware, and may need only to request a volume of specified size and performance. Upon initialization, a corresponding volume may be linked to and/or connected to a specific compute instance (e.g., host) operating at a corresponding CSP.

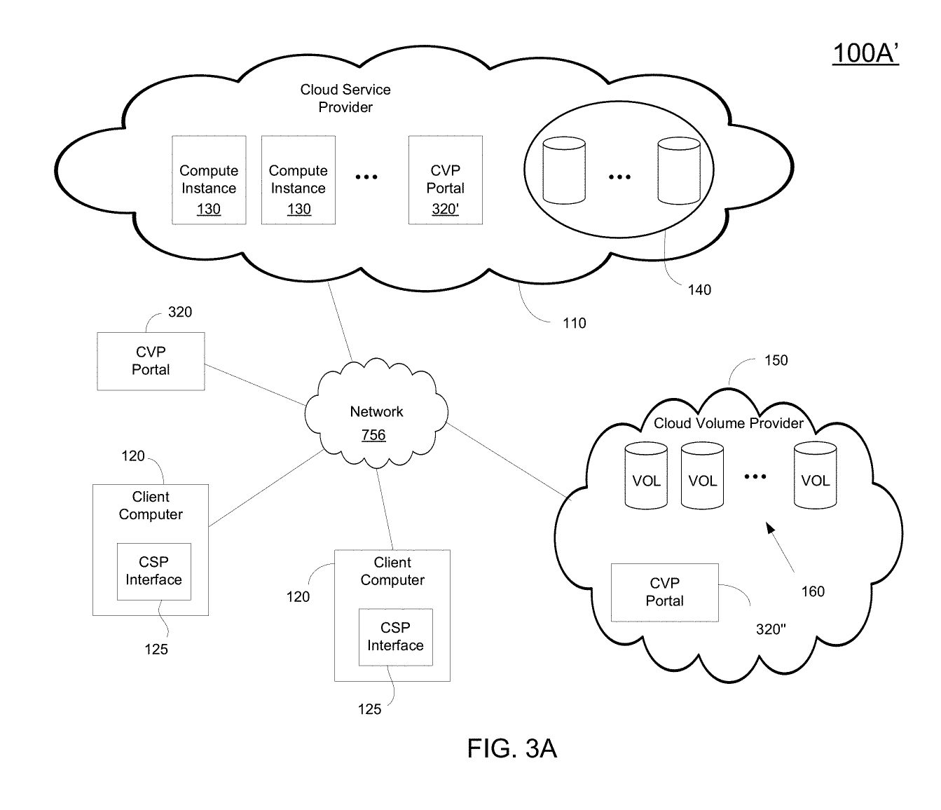

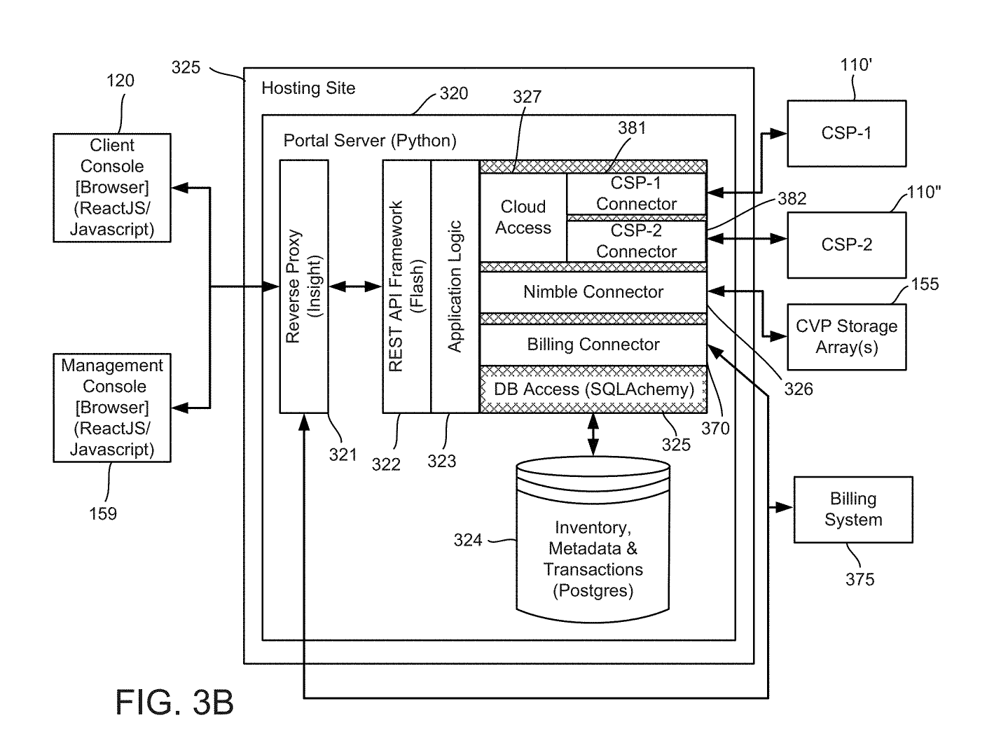

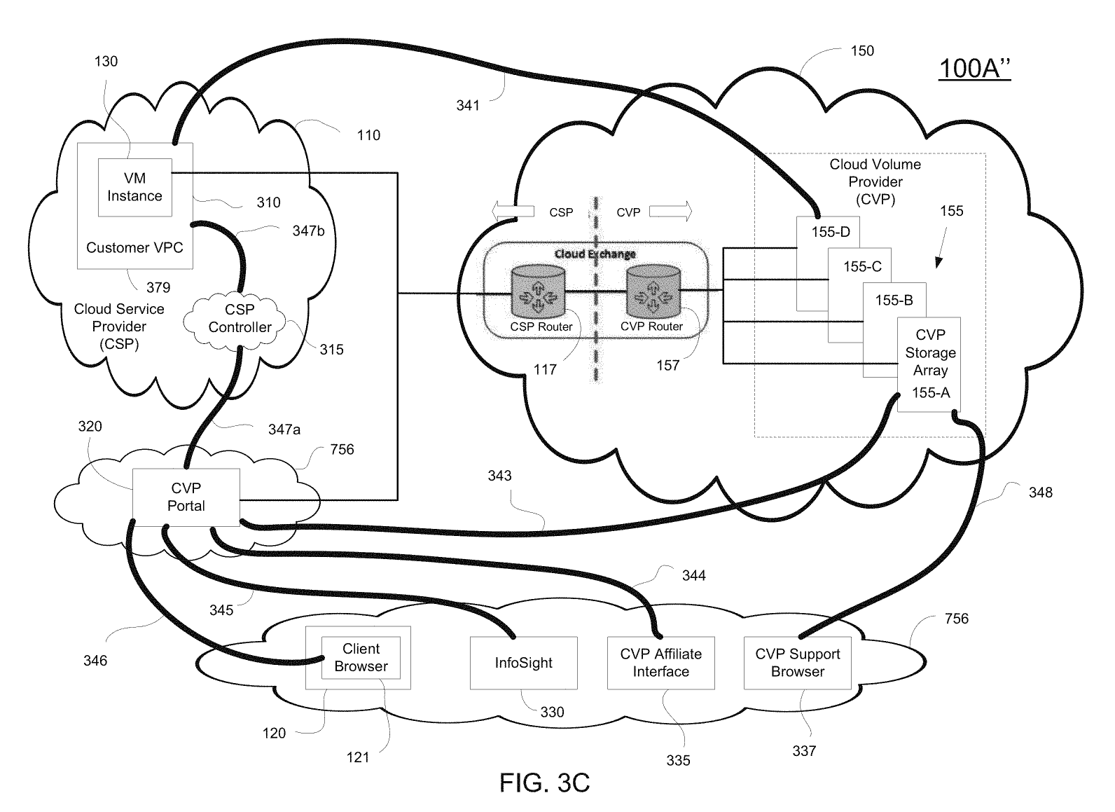

Storage from the storage arrays may be accessible via a web portal, where customers may assign one or more volumes of storage to a compute node of a CSP 110. In particular, each of the logical volumes associated with the CVP 150 may be defined by a corresponding entity upon initialization, and may be further linked to a corresponding compute instance. Upon initialization, the volume 160-A may initially be configured by an amount of storage (e.g., size), performance (e.g., IOPS), and information linking volume 160-A with a corresponding compute instance 130-A. For example, the instance 130-A may be associated with a single application. Any time an instance is instantiated to run the application, that instance (e.g., instance 130-A) may be configurable to link with the volume 160-A without re-initializing the link between the volume 160-A and the instance 130-A. Initialization and configuration of the volume 160-A may be implemented through a CVP portal, as will be further described in relation to FIGS. 3A-3C. As shown in FIG. 1B, a cloud compute instance 130-A, of a cloud service provider—CSP-1 110′, may be linked to the specific volume 160-A within the storage arrays of the cloud volume provider 150. In that manner, instead of storing data generated by the compute instance 130-A when executing one or more applications on the data storage 140 provided by the CSP-1 110′, data may be stored at the volume 160-A at the CVP 150.

FIG. 1C illustrates an example system 100C including a cloud volume provider 150 offering cloud storage for use by one or more compute instances across multiple cloud service providers (e.g., CSP-1 (110′), CSP-2 (110″) through CSP-n (110′″). In some examples, a single entity may operate the compute instances. In other examples, one or more entities may operate the compute instances. The system 100C may build upon the architecture of system 100A shown in FIGS. 1A-1B, in one example.

As shown in FIG. 1C, the CVP 150 may operate a plurality of volumes 160 across a distributed network of commercial data centers. For example, storage arrays located at a first data center may be combined with storage arrays located at a second data center. The combination may provide a plurality of volumes available to one or more compute instances operating at one or more CSPs 110.

In addition, each of the CSPs 110 may offer virtualized cloud computing resources to one or more consumers over a network 756. More particularly, the CSP-1 (110′) may include one or more virtualized compute instances 130 operating within a virtualization layer. Other CSPs, including the CSP-2 (110″) and the CSP-n (110′″), may be similarly configured, each of which including one or more virtualized compute instances 130 operating within a corresponding virtualization layer.

One or more entities may use a CVP portal to link compute instances executing on corresponding CSPs and running applications with cloud volumes at the CVP 150. In this manner, entities using the CVP 150 may elect to use cloud storage instead of storage provided by a corresponding CSP. Further, the use of third party cloud volume storage may be limited to critical data of associated applications running on corresponding compute instances. That is, for a particular entity, some compute instances may still use the default storage provided by the CSP, while other compute instances handling more premium data may use cloud volume storage of the CVP 150. The cloud storage provided by the CVP 150 may be implementable in one or more commercial data centers, in which the storage arrays may be routed to specific routers that provide access and interconnectivity to instances running in a corresponding CSP. In particular, an entity may to utilize multiple cloud service providers, in which the CVP 150 may be configurable to assign one or more volumes to compute instances across all of the multiple CSPs. Communication between the CVP 150 at each data center and a corresponding CSP may be implemented through the network 756, in which routers and/or switches at both ends may facilitate travel over the network 756. For example, a switch/router 431 at the CSP-1 (110′) and the switch/router 431′ at corresponding data centers for the CVP 150 (e.g., each of the data centers housing storage arrays for CVP 150) may facilitate communication between a linked compute instance 130 executing at the CSP-1 (110′) and a corresponding logical volume. In addition, a switch/router 432 at CSP-2 (110″) and a switch/router 432′ at corresponding data centers for the CVP 150 (e.g., each of the data centers housing storage arrays for the CVP 150) may facilitate communication between a linked compute instance 130 executing at the CSP-2 (110″) and a corresponding logical volume. Further, a switch/router 433 at the CSP-n (110′″) and the switch/router 433′″ at corresponding data centers for the CVP 150 (e.g., each of the data centers housing storage arrays for the CVP 150) may facilitate communication between a linked compute instance 130 executing at the CSP-n (110′″) and a corresponding logical volume.

In the example of a single entity, operating multiple compute instances across multiple CSPs, the CVP 150 may provide for multiple CSP access. For instance, an entity may have an instance running on the CSP-1 (110′) (e.g., Amazon Web Services) and another instance running on the CSP-2 (110″) (e.g., Azure by Microsoft). The CVP portal may enable sharing of volumes between compute instances of more than one cloud service provider.

FIG. 2 illustrates an example cloud service provider 110 offering processing and data services to entities. The CSP 110 may be implemented within one or more commercial and/or private data centers (not shown) providing computing support (e.g., power and network connectivity). As previously described, the entities typically connect to the CSP 110 over a network 756 to support applications that may be executing on virtual machines or compute instances 130 of the CSP 110.

For example, the CSP 110 may operate a plurality of virtual machines (VMs) or compute instances, such as VM-1 (130-x), VM-2 (130-y), and VM-n (130-z). As shown, VM-1 (130-x) may be implemented using an operating system (OS 211-x) (e.g., Windows, Linux, Apple operating system, etc.) which is executing a single application-1. Also, VM-2 (130-y) may be implemented using an OS 211-y, which may be similar or different than an OS 211-x, and which may be executing a plurality of applications (e.g., application-x, application-y . . . , and application-z). Further, the VM-n (130-z) may be implemented using OS 211-z, which may be similar or different than each of the OS 211-x and the OS 211-y, and which may execute a single application-2. For example, the application-1 and the application-2 may be enterprise applications supporting human resource databases.

The virtual machines or compute instances may be rendered using a virtualization layer 260 that is to manage and allocate resources from corresponding physical hardware for utilization by the plurality of compute instances or VMs (e.g., VM-1, VM-2, VM-n), such that the virtual hardware present in each VM is supported by underlying hardware 270. As such, the virtualization layer 260 may provide a virtualized set of hardware, supported by underlying physical hardware 270 to each guest operating system of a corresponding guest VM or compute instances VM-1 (130-x), VM-2 (130-y) . . . , VM-n (130z).

The physical hardware 270 may include components such as a central processing unit (CPU) 271, general purpose random access memory (RAM) 272, 10 module 273 for communicating with external devices (e.g., USB port, terminal port, connectors, plugs, links, etc.), one or more network interface cards (NICs) 275 for exchanging data packages through a network, and one or more power supplies 274. Other hardware components, such as a temperature sensor, are not shown for brevity and clarity.

FIG. 3A illustrates an example system 100A′ including a cloud volume provider 150 offering cloud storage for use by one or more compute instances of a cloud service provider 110 and a CVP portal 320 to link logical volumes in the CVP 150 to compute instances in the CSP 110. The system 100A′ may be similar in configuration to the system 100A depicted in FIGS. 1A-1B, and may also include the CVP portal 320 to provide third party cloud storage to compute instances of one or more CSPs 110. More specifically, FIG. 3A illustrates possible locations where the CVP portal 320 may be located within the network architecture of the system 100A′.

In particular, the system 100A′ may include the CSP 110, which may offer virtualized cloud computing instances 130 to one or more entities over a network 756. The compute instances may be instantiated and/or accessed by one or more entities associated with the one or more client computers 120 through communication network 756 (e.g., the Internet). Each client computer 120 may include a CSP interface 125 to access and operate a corresponding compute instance 130. The CSP 110 may also include the storage 140 that may be maintained and operated for customer use. However, according to examples, selected compute instances 130 may avoid using the default storage 140, and may instead use one or more cloud volumes 160 that the CVP 150 may provide.

As shown in FIG. 3A, the CVP portal 320 may initialize a link between a logical volume 160 provided by the CVP 150 and a compute instance 130 of a particular CSP 110, in one example. In other examples, the CVP portal 320 may initialize multiple links between a logical volume 160 and multiple compute instances 130 of a particular CSP 110. In other examples, the CVP portal 320 may initialize multiple links between a logical volume 160 and multiple compute instances 130 located on two or more CSPs 110.

In particular, the CVP portal 320 may provide an interface for the entity to configure and initialize corresponding cloud volumes in the CSP 150. As shown in FIG. 3A, the CVP portal 320 may be on a compute node that is accessible through the network 756. In other examples, the CVP portal 320′ may be configured as a compute instance within a corresponding CSP 110. Because the CVP portal 320′ is located within the CSP 110, this may be beneficial for configuration access to compute instances 130 on the CSP 110 utilizing logical volumes provided by the CVP 150, in some cases. In some other examples, the CVP portal 320″ may be located within the logical boundaries of the CVP 150. In each of these locations, the CVP portal 320″ may create and/or initialize a volume within the CVP 150, and link that volume to a corresponding compute instance executing on a corresponding CSP 110. For brevity and clarity, the features and functions of the CVP portal 320 are described in relation to FIGS. 3A-3C, and are intended to represent the features and functions of the CVP portal 320′ and 320″.

In general, the CVP portal 320 may allow an entity using one or more instances 130 running on one or more CSPs 110 to select a corresponding logical volume at the CVP 150. In that manner, an application that is running on one or more instances across one or more CSPs 110 may access that volume through initialization via the CVP portal 320. For example, an entity may login into their instances running on the CSP 110, and then select existing or new volumes from the CVP 150. Login to a particular CSP 110 may be performed directly, or through the CVP portal 320 for purposes of configuration and linking (e.g., between a compute instance and a volume). For example, the CVP portal 320 may use the login parameters to communicate with a particular CSP 110 through the customer interface of the CSP 110. As such, the CVP portal 320 may create the link between the one or more compute instances 130 running in the one or more CSPs 110 and the one or more volumes supported by the storage arrays of the CVP 150. As a result, selecting storage may be reduced to a decision of how much storage and how much performance. Entities may then simply be charged for what they use and there is no need on their part to own and/or manage any hardware.

In some examples, the CVP portal 320 may create new volumes for use by compute instances running on one or more CSPs 110. For example, when initializing a volume, certain parameters may be set, including a volume size (amount of storage), a volume identifier (e.g., name), and performance (e.g., IOPS). Additional parameters may be used, including whether encryption is on or off, the use of an encryption key, an application type or category, an application identifier, and other additional feature options (e.g., snapshot schedule and retention). Still other information and/or parameters defining the volume may include a data transfer for a current billing period (e.g., month), cost monitoring (e.g., fixed+variable), volume usage, etc.

In some examples, a CSP connection may also be included for initialization. In other examples, the CSP connection (e.g., IP and IQN details) and CSP identifier may be optional. In that case, a volume may exist in an unconnected state, but may be ready for use when a connection is specified. The volume and CSP connection to an OS of a compute instance may be implemented over iSCSI, as supported by the corresponding CSP.

When provisioning a volume, any CSP may be selected for linking. That is, the systems disclosed herein may be CSP agnostic, and may support one or more CSPs. As such, the CVP 320 may collect all necessary information to connect to a logical volume to a selected CSP supporting a linked compute instance 130. In addition, multiple CSPs may be linked to a single volume of a CVP 150 during volume creation.

In some examples, the CVP portal 320 may be configured for CSP modification and/or removal. As such, for a particular volume, the CVP portal 320 may allow for updating and/or removal of one or more linked CSP connections. In one instance, a volume must be disconnected from the CVP 150 and the CVP 150 configuration may be removed by the customer.

In another example, the CVP portal 320 may be configured for volume removal and/or modification. In that manner, provisioned volumes may be deleted. In one instance, if values for a CSP connection are deleted from a profile, then the CSP connection may also be removed. In another example, the CVP portal 320 may be configured for volume modification. In that manner, an existing volume may modify one or more of its attributes, including CSP connection, volume size, volume name, snapshot scheduling and retention, etc.

The use of the CVP portal 320 by an entity may allow for flexible use of storage resources according to usage needs. For example, at any particular time, an entity may be running one or more applications on one or more compute instances over one or more CSPs. The one or more compute instances may be accessing one or more volumes. In one implementation, the entity may configure one application running on one or more compute instances accessing one or more associated volumes to operate at a certain level of performance. The same entity may configure another application running on another set of compute instances accessing another set of one or more associated volumes to operate at a different level of performance. In that manner, varying grades of data management may be configurable through volume creation (e.g., specifying size and performance).

FIG. 3B illustrates an example operation of a CVP portal 320 to link a specific volume within a storage array of a cloud volume provider to a cloud compute instance of a cloud service provider. As shown, the CVP portal 320 may provide a linking interface between an entity operating a browser of a client console or a computer 120, logical volumes of storage arrays 155 of a CVP 150, and compute instances located on one or more CSPs, such as CSP-1 (110′) and CSP-2 (110″). As shown, the CVP portal 320 may sit within a hosting site, as previously described in relation to FIG. 3A (e.g., located on a remote compute node, as a CSP compute instance, configured within the CVP 150, etc.).

The CVP portal 320 may be viewed as a pane of glass through which entities/users of the CVP 150 may manage and monitor their cloud volume resources. The interface may provide a view into the storage configuration, and may include volume information. For instance, the volume information may include: CSP information, CSP connection, volume name, volume size, volume usage, etc. All browsers may be supported, such as Firefox, Safari, Chrome, Edge, etc. The database access information 325 may be provided to allow for storing metadata, transaction information, and inventory information in a database 324. The application logic 323 may execute the CVP portal 320 functionality. An application programming interface 322 may provide access to the application logic 323. A reverse proxy component 321 may allow for the CVP portal 320 to act as a proxy for the entity when accessing a corresponding CSP.

The CVP portal 320 may provide linking information for CSP access and CVP access. For instance, a cloud access component 327 may include CSP connector/connection information. As shown, the CSP-1 connector/connection information 381 may be included for defining a communication path to the CSP-1 (110′). Also, the CSP-2 connector/connection information 382 may be included for defining a communication path to the CSP-2 (110″). The CVP portal 320 may also provide linking information to the CVP storage arrays 155 of the CVP 150 via the CVP connector/connection information 326. In that manner, a link may be provided between a compute instance of a CSP and a corresponding logical volume using the CSP connector/connection information and the CVP connector/connection information.

In addition, the CVP portal 320 may also facilitate billing. In particular, billing connector 370 may include information and functionality used to communicate with the billing system 375 that may be located on a remote server over a network 756.

The CVP 320 may be configured for payment setup and modification of billing. In that manner, the CVP 320 may provide a way to setup payments and to access billing details. In that manner, a CVP 150 customer may review and/or modify billing information through further action by providing a way for customers to view past payments and projected costs.

The CVP portal 320 may enable or disable snapshot creation for a corresponding volume. Further, the CVP portal 320 may allow for snapshot scheduling, configuration, and modification, to be able to set or change the snapshot schedule for an existing volume. In one implementation, the CVP portal 320 may act on a single volume at a time, and not a group of volumes. In another implementation, the CVP portal 320 may provide for a snapshot restore, in which a volume state may be restored to a previously captured snapshot. Again, this may apply to a single volume, and not to a group of volumes, in some examples.

FIG. 3C illustrates an example system 100A″ including a cloud volume provider 150 offering cloud storage for use by one or more compute instances 130 of a cloud service provider 110, and a CVP portal 320 to link logical volumes in the CVP 150 to compute instances 130 in the CSP 110. The system 100A″ may be similar in configuration to the system 100A depicted in FIGS. 1A-1B, and the system 100A′ depicted in FIGS. 3A-3B. As previously described, the CVP portal 320 may provide third party cloud storage to compute instances of one or more CSPs 110 by linking a specific logical volume in the CVP 150 to a corresponding compute instance in a CSP 110. In addition, a logical volume may be linked to one or more compute instances of one or more CSP 110s, in another example. In particular, FIG. 3C illustrates example communication paths for customers accessing logical volumes in a cloud volume provider.

As previously described, the system 100A″ may include a CSP 110 that may offer virtualized cloud computing instances 130 to one or more entities over a network 756. The compute instances 130 may be instantiated and/or accessed by one or more entities associated with the one or more client computers 120 operating browsers 121 through a communication network 756 (e.g., the Internet). For example, an entity may create a virtual private cloud (VPC) 379 that includes one or more compute instances 130. A CSP controller 315 may provide for management and configuration control of the compute instances 130 of a customer VPC. For example, the CSP controller 315 may provide for linking communication paths between the compute instance 130 and a logical volume of the CVP 150. In addition, the CVP 150 may include one or more storage arrays (e.g., arrays 155-A through 155-D, etc.). The CVP 150 may be distributed throughout one or more commercial data centers, and may be configurable to provide a plurality of logical volumes 160.

A cloud exchange on the local border of the CVP 150 may provide router to router communication between the CSP 110 and the CVP 150. For instance, the CSP router 117 and the CVP router 157 at the CVP 150 may facilitate communication to and from logical volumes associated with a particular compute instance supported by the CSP 110.

FIG. 3C illustrates an example communication path 346 between the browser 121 of the entity and the CVP portal 346 over a public cloud (e.g., the Internet). In that manner, the CVP portal 320 may initialize a link between a logical volume 160 provided by the CVP 150 and a compute instance 130 of a particular CSP 110, in one example. In another example, the CVP portal 320 may initialize multiple links between a logical volume 160 and multiple compute instances 130 of a particular CSP 110. In still another example, the CVP portal 320 may initialize multiple links between a logical volume 160 and multiple compute instances 130 located on two or more CSPs 110.

The communication path 347a may be implemented between a public cloud (e.g., network 756) and a virtual private cloud (VPC) 379 within the CSP 110 via the CSP controller 315. A customer login provided to the CVP portal 320 (e.g., user identifier and password) may be communicated securely over HTTPS on the communication path 347 to configure the compute instance 130 of the VPC 379 with the correct connections to the logical volume over the network 756. The communication path 347b may be implemented between the CVP portal 320 and the compute instance 130 via the CSP controller 315. The path 347b may be implemented within two private clouds at CSP 110. In another implementation, the path 437b may be implemented between a virtual private network between CSP-1 and CSP-2 over the network 756 (not shown).

The communication path 343 may be implemented between the CVP portal 320 and the storage array 155 of the CVP 150. This path may be taken to configure the logical volume that is linked to a corresponding compute instance. The CVP portal 320 may communicate across two private networks (e.g., supporting the CVP portal 320 and the CVP 150) in order to access the private network of the CVP 150 at a commercial data center over a secure communication session for configuration purposes using an authentication sequence, for example.

The communication path 341 may be implemented between a compute instance 130 and the storage array 155 of the CVP 150. The communication path 341 may provide communication between a VPC 379 of the entity (e.g., communicating through to the CSP router 117 at the CVP 150 logical border) at the CSP 110 and a private network within the CVP 150 (e.g., behind CVP router 157). In some examples, this communication may be a direct communication that does not use any public networks (e.g., the Internet). In other examples, the communication path 341 may be implemented through a combination of public and private networks with security features implemented (e.g., encryption at rest, encryption “on the wire” may be provided by the applications operating on compute instance 130).

Additional features may be implemented through servers at remote compute nodes operating over network 756. For example, communication path 348 may be implemented between a CVP support browser 337 and the storage arrays 155 of the CVP 150. In that manner, management and control over the storage arrays 155 may be performed. The communication path 348 may be implemented between a public cloud network 756 (e.g., the Internet) and a private network within the CVP 150. In addition, the communication path 344 may be implemented between the CVP portal 320 and a CVP affiliate interface 335 (e.g., one that provides billing for the CVP 150) to provide billing information that is viewable to the end user through the CVP portal 320. The communication path 344 may be implemented between a public cloud network 756 (e.g., the Internet) and a private network for the affiliate.

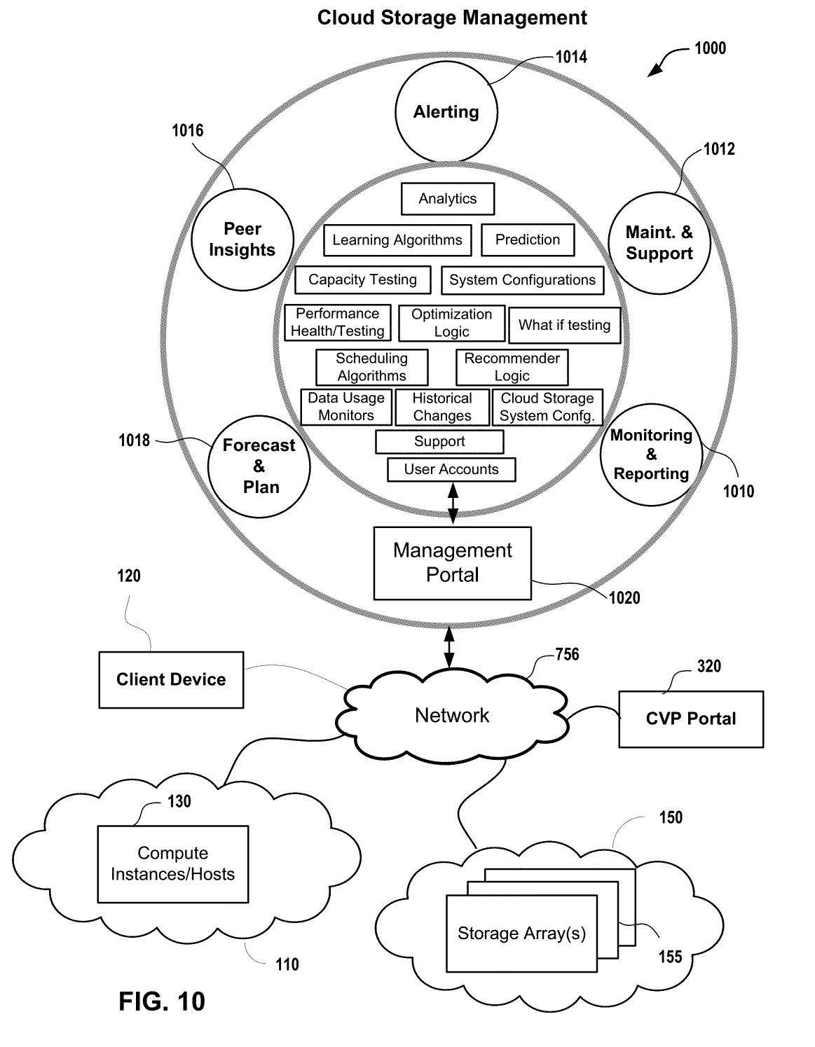

The communication path 345 may be implemented between the CVP portal 320 and The infoSight service 330, which may provide for data analytics based on IO performance monitoring of data stored and accessed via the logical volumes at the CVP 150. The communication path 345 may be implemented between a public cloud network 756 and a private cloud network for InfoSight to provide secure communications. InfoSight may provide data analytics to be performed for executing computing instances across one or more cloud services providers. The analysis may also include use of metrics collected from multiple installed cloud volumes to predict use needs, optimization considerations and monitor performance of specific cloud service provider instances. For example, data analytics may indicate when an entity may be predicted to exceed capacity on a volume, and may make recommendations to change the volume parameters (e.g., increase the volume size). As such, using this data, end users may be provided with guidance as to the best optimized configuration, based on their application and data needs. The predictions may include determining when a customer setup is about to run out of space and methods for adding more volume space via the portal. Additionally, dashboards may be provided that inform end users of their data usage trends, volume performance, capacity per volume, and recommendations for resizing volumes, etc. Further, data analytics may provide a view into the performance of one or more CSPs, based on their interactions with storage arrays 155 of CVP 150. A more detailed discussion on the features offered by the InfoSight service 330 is provided with respect to FIG. 10 below.

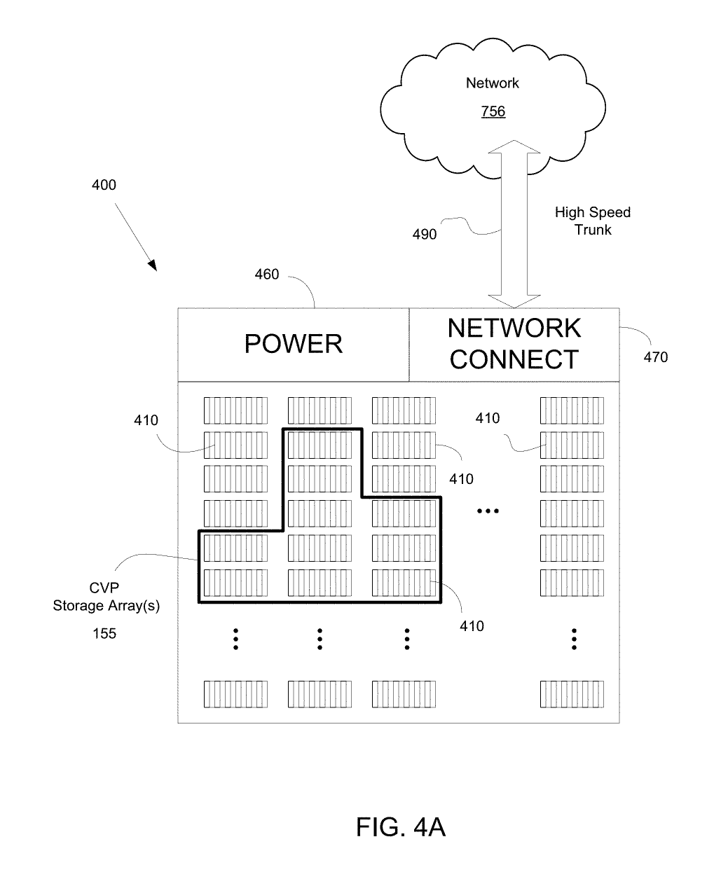

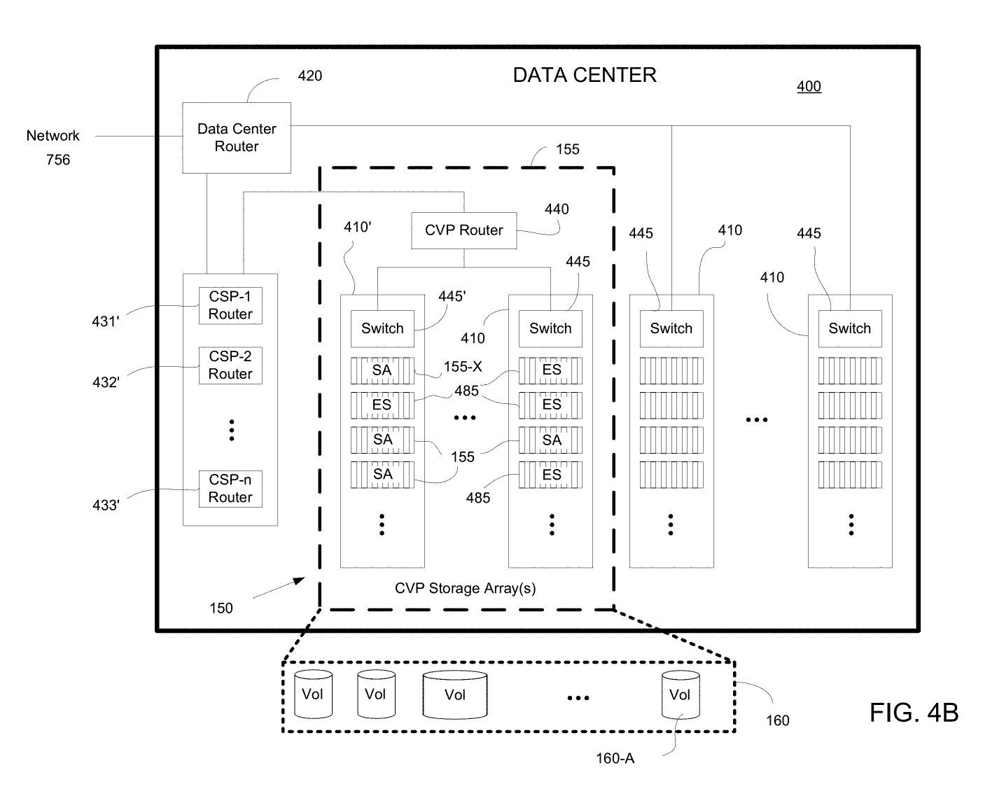

FIG. 4A illustrates an example data center 400, in which a cloud volume provider 150 may implement operations of the cloud volume provider 150 within the data center. In particular, the data center 400 may provide basic computing and network access and resources, such that the data center customer may essentially lease space to run its hardware that are operating within the racks 410 provided by the data center 400. As shown, the data center 400 may provide network connectivity 470 over a high speed connection (e.g., high speed trunk) 490 to the public network 756. In addition, the data center 400 may provide power for its customers. Because the data center 400 may be large and nay accommodate many customers, the power consumed may rival the consumption of a medium sized metropolis. It may be noted that network connectivity and power may remain constant for the data center customers, in which the data center 400 may provide redundancies when supplying power and connectivity.

The data center customer may provide the hardware and essentially leases space within the data center 400. The data center 400 may provide power and network connectivity to a particular customer, as negotiated. The data center 400 may support multiple customers, including the CVP 150. For example, the CVP 150 may configure one or more storage arrays 155 within a particular data center 400. That is, the storage arrays may be placed into one or more identified, physical racks, in which the storage arrays include containers configured with controllers, hard drive and flash drive storage, and expansion shelves containing additional storage.

FIG. 4B illustrates example communication paths between one or more cloud service providers and a cloud volume provider 150 within a data center 400. In particular, the data center 400 may include a plurality of racks 410, which are also known as cages, since they may be located for security. Each rack may include a switch 445 that may provide for local communication between computing resources installed in the racks and routers within the data center 400. For example, a switch 445 of a corresponding rack may communicate with a data center router 420 to enable communication over the network 756.

As shown in FIG. 4B, the CVP 150 may include one or more storage arrays 155 arranged within one or more racks 410. Expansion shelves 485 containing additional storage may also be installed onto one or more racks 410, in which an expansion shelf 485 may provide additional storage to a corresponding storage array 155. The storage arrays 155, singly or in combination, may be further configured virtually into a plurality of volumes. Each of the racks 410 may include a switch 445 that may communicate with a CVP router 440, in which the CVP router 440 may communicate with each of the CSP routers (e.g., CSP-1 router 431′, CSP-2 router 432′ . . . , CSP-n router 433′) depending on which logical volume and linked compute node are communicating. More particularly, a CSP may manage its own CSP router at the data center 400 to provide for direct communications between the CSP and the data center, in which the direct communications allows for greater bandwidth and speed. As such, a compute instance on the CSP communicates with the data center 400 through the corresponding router. For instance, the CSP-1 (110′) may send and receive data packets via the CSP-1 router 431′ when communicating with the data center 400.

As such, the CVP 150 may be able to take advantage of the direct communication between the CSP and the data center 400 by directly communicating with the corresponding CSP router located on the other side of the CVP 150. For example, communications between logical volumes within the storage arrays 155 communicating with a compute instance on the CSP-1 (110′) may occur over a data path internal to the data center that includes the CVP router 440 and the CSP-1 router (431′). As an illustration, communications between the logical volume 160-A on the SA 155-X and the compute instance on the CSP-1 (110′) may be delivered via the CVP router 440 and the CSP-1 router (431′) at the data center 400, in which the logical volume 160-A is linked to a compute instance at CSP-1 (110′). In particular, a data packet from the SA 155-X may be delivered to the switch 445′ to the CVP router 440, which may then be delivered to the CSP-1 router 431′, which lies on the logical border of the CVP 150. That data packet may be delivered over the data center router 420 and then out to the network 756. From there, the data packet may be delivered to the CSP-1 router 431 at the CSP-1 (110′) and then delivered internally to the corresponding compute instance 130. Similarly, data packets from the compute instance 130 on the CSP-1 (110′) to the logical volume 160-A configured on the SA 155-X are delivered over the same path.

Further, communications between logical volumes within the storage arrays 155 communicating with a compute instance on the CSP-2 (110″) may communicate over a data path internal to the commercial data center 400 that includes the CVP router 440 and the CSP-2 router (432′). From there, the communications may go through the data center router 420, the network 756, and the CSP-2 router 432 located at the CSP-2 (110″). In addition, communications between logical volumes within the storage arrays 155 communicating with a compute instance on CSP-n (110′″) may communicate over a data path internal to the data center 400 that includes the CVP router 440 and the CSP-n router (433′). From there, the communications may go through the data center router 420, the network 756, and the CSP-n router 433 located at the CSP-n (110′″).

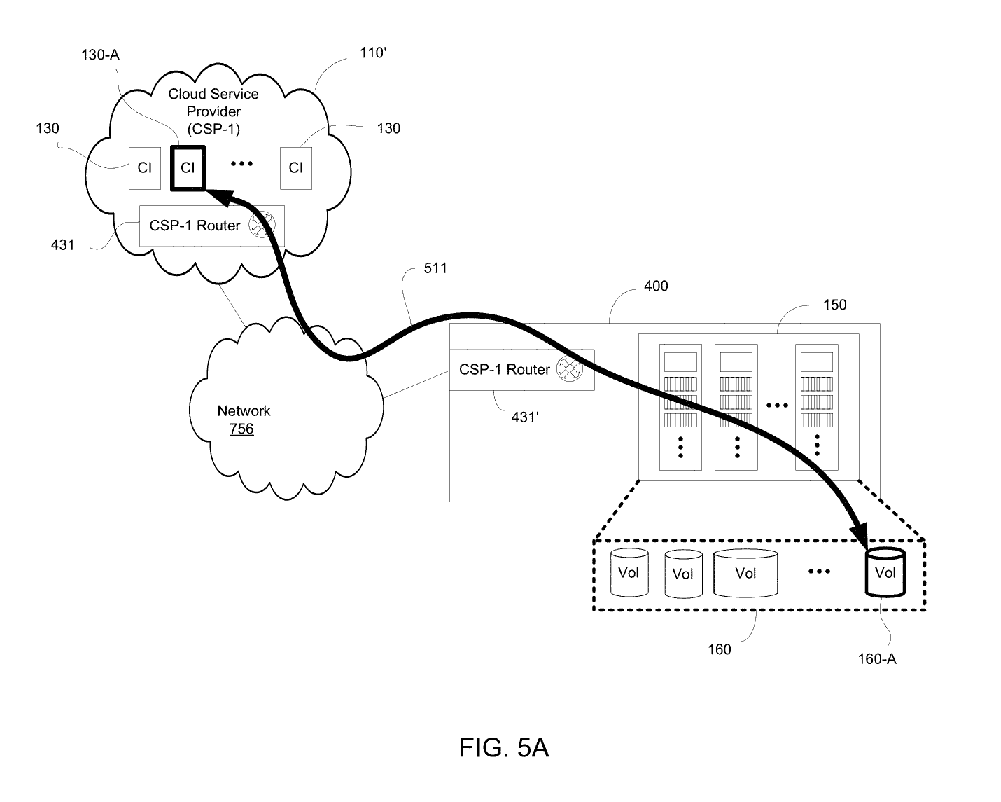

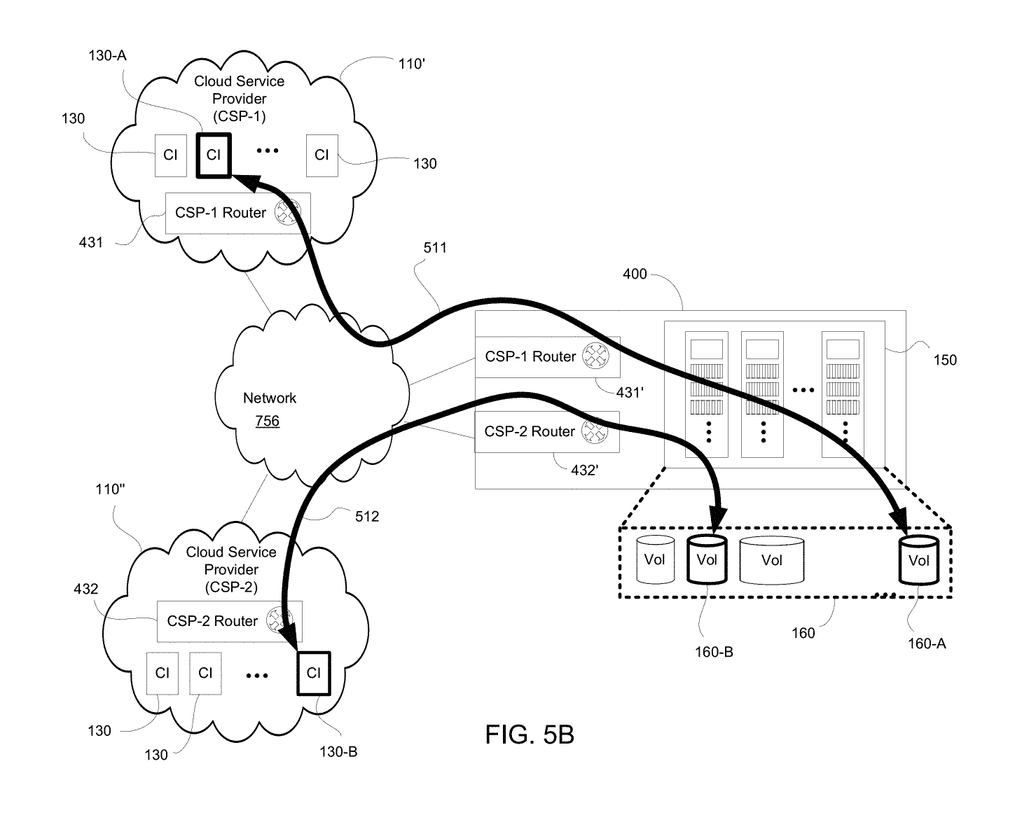

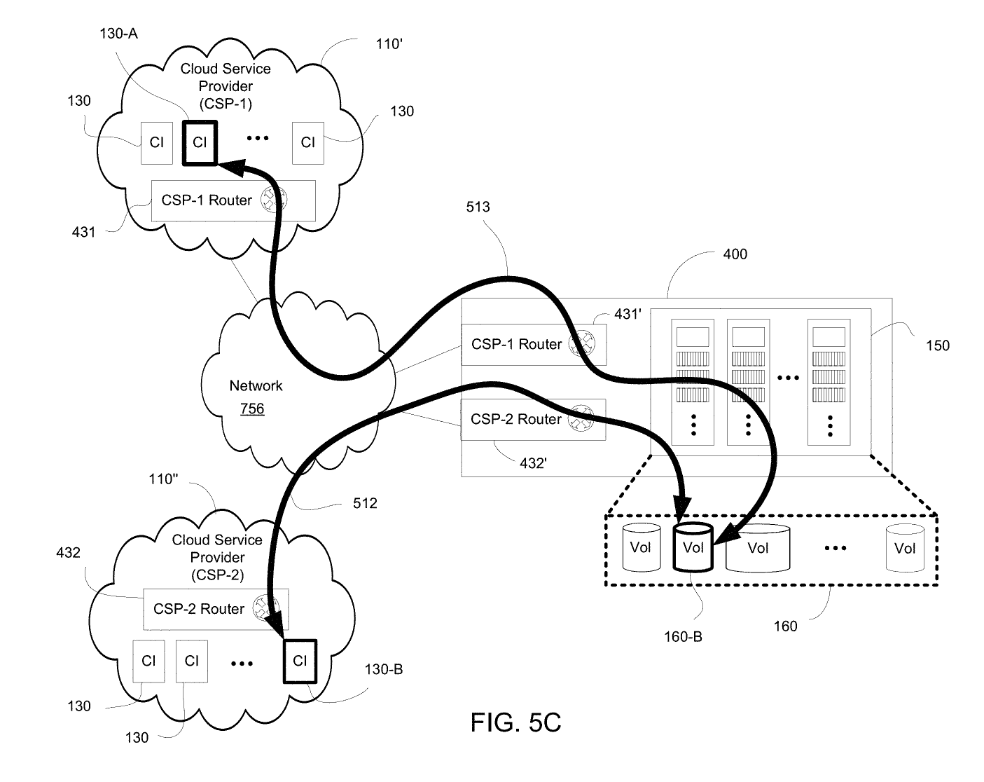

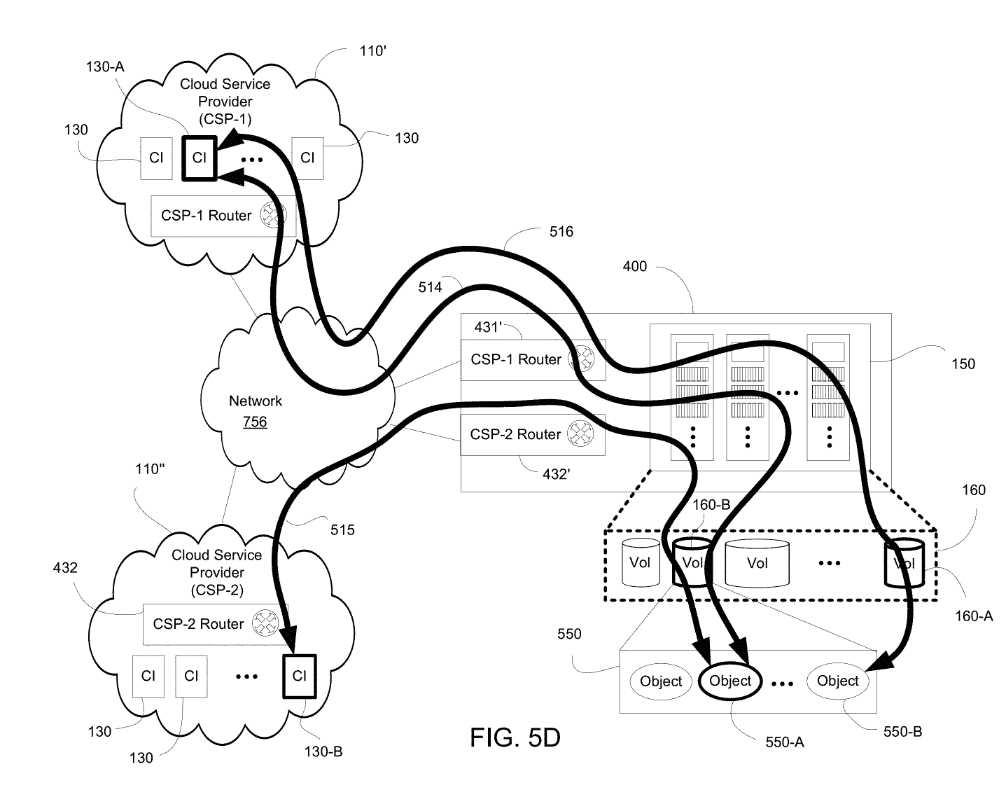

FIG. 5A illustrates an example communication path 511 between a compute instance 130-A of a cloud service provider CSP-1 (110′) to a specific volume 160-A within a storage array 155 of a cloud volume provider 150 within a data center 400. FIG. 5A extends the network architecture shown in FIG. 4B out to the CSP-1 (110′). As shown, a compute instance 130-A on the CSP-1 (110′) may be linked to a logical volume 160-A located at the CVP 150. For example, referring to FIG. 4B, the logical volume 160-A may be physically located on a storage array (SA) 155-X of one rack 410′, in which the logical volume 160-A is linked to a compute instance of the corresponding CSP-1 (110′). Internally within the data center 400, the communication path to the logical volume may include a switch 445′, the CVP router 440 and the CSP-1 router (431′), and the data center router 420 at the data center 400. Referring back to FIG. 5A, extending the communication from the data center 400 as between the logical volume 160-A on the SA 155-X and the compute instance on the CSP-1 (110′), extending from the data center 400, the communication path 511 may further include the CSP-1 router 431′ (via data center router 420), the network 756, and the CSP-1 router 431 at the CSP-1 (110′). Internal to the CSP-1 (110′) internal communication paths may lead to the corresponding compute instance.

FIG. 5B illustrates example communication paths between a plurality of compute instances of a plurality of service providers accessing volumes within one or more storage arrays of a cloud volume provider within a data center, in which the compute instances may be associated with one or more entities. FIG. 5B extends the network architecture shown in FIGS. 4B and 5A out to both the CSP-1 (110′) and the CSP-2 (110″).

As shown, a compute instance 130-A on the CSP-1 (110′) may be linked to a logical volume 160-A located at the CVP 150. As described previously with respect to FIGS. 4B and 5A, a communication path 511 is shown linking the compute instance 130-A to the logical volume 160-A and may include the CSP-1 router 431 located at the CSP-1 (110′), the network 756, the data center router 420, the CSP-1 router 431′ located at the commercial data center 400, the CVP router 440, and a corresponding switch 445′ of a rack 410′ configured with the logical volume 160-A.

Furthermore, a compute instance 130-B on the CSP-2 (110″) may be linked to a logical volume 160-B also located at the CVP 150. Referring both to FIG. 4B and FIG. 5B, internally within the commercial data center 400, the communication path 512 to the logical volume 160-B may include a corresponding switch 445 of a corresponding rack 410, the CVP router 440 and the CSP-2 router (432′), and the data center router 420 at the data center 400. Referring back to FIG. 5B, extending the communication from the data center 400 as between the logical volume 160-B and the compute instance 130-B on the CSP-2 (110″), extending from the data center 400, the communication path 512 may further include the CSP-2 router 432′ (via data center router 420), the network 756, and the CSP-2 router 432 at the CSP-2 (110″). Internal to the CSP-2 (110″) internal communication paths lead to the corresponding compute instance 130-B.

FIG. 5C illustrates example communication paths between a plurality of compute instances of a plurality of service providers accessing a single volume within a storage array of a cloud volume provider within a data center, in which the compute instances may be associated with one or more entities. FIG. 5C extends the network architecture shown in FIGS. 4B, 5A, and 5B out to both the CSP-1 (110′) and the CSP-2 (110″).

As shown, a compute instance 130-B on the CSP-2 (110″) may be linked to a logical volume 160-B located at the CVP 150. As described previously in FIGS. 4B and 5B, a communication path 512 is shown linking the compute instance 130-B to logical volume 160-B and includes the CSP-2 router 432 located at the CSP-2 (110′), the network 756, the data center router 420, the CSP-2 router 432′ located at the data center 400, the CVP router 440, and a corresponding switch 445 of a corresponding rack 410 configured with the logical volume 160-B.

Furthermore, the compute instance 130-A on the CSP-1 (110′) may be reconfigured or initially configured to be linked also to a logical volume 160-B located at the CVP 150. Referring both to FIG. 4B and FIG. 5C, internally within the data center 400, the communication path 513 to the logical volume 160-B may include a corresponding switch 445 of a corresponding rack 410, the CVP router 440 and the CSP-1 router (431′), and the data center router 420 at the data center 400. Referring back to FIG. 5C, extending the communication from the data center 400 as between the logical volume 160-B and the compute instance 130-A on the CSP-1 (110′), extending from the data center 400, the communication path 513 may further include the CSP-1 router 431′ (via the data center router 420), the network 756, and the CSP-1 router 431 at the CSP-1 (110′). Internal to the CSP-1 (110′) internal communication paths may lead to the corresponding compute instance 130-A.

As previously introduced, the compute instance 130A on CSP-1, and the compute instance 130B on CSP-2 may belong to the same entity, or to different entities. In that manner, a single volume 160-B may be simultaneously linked to and accessible by compute instances operating on multiple CSPs.

FIG. 5D illustrates an example cloud volume provider 150 offering configurable logical volumes of storage, in which a cloud compute instance of a cloud service provider may be linked to a specific object stored within a logical volume. That is, the link or association between a compute instance 130 of a CSP may be extended to a data object, with or without a corresponding association to a logical volume. Broadly speaking, a data object may simply be a way of organizing or identifying data. Data may be organized and accessed by way of folders, files, and/or objects. As a result, compute instances 130 may be supported by corresponding CSPs with data objects, so that storage arrays 155 holding the data objects may be accessed by the cloud based compute instances 130.

As shown in FIG. 5D, a compute instance 130-A on the CSP-1 (110′) may be linked to a data object 550-B located at the CVP 150. In examples, the data object 550-B may be located within the volume 160-A. A communication path 516 is shown linking the compute instance 130-A to the data object 550-B, such as through the volume 160-A, and may include the CSP-1 router 431 at the CSP-1 (110′), the network 756, the data center router 420, the CSP-1 router 431′ located at the data center 400, the CVP router 440, and a corresponding switch 445 of a corresponding rack 410 configured with logical volume 160-A that holds the object 550-B.

Further, the compute instance 130-A on the CSP-1 (110′) may also be linked to a data object 550-A located at the CVP 150. In some examples, the data object 550-A may be located within the volume 160-B. A communication path 514 is shown linking the compute instance 130-A to the data object 550-A, such as through volume 160-B, and may include the CSP-1 router 431 at the CSP-1 (110′), the network 756, the data center router 420, the CSP-1 router 431′ located at the data center 400, the CVP router 440, and a corresponding switch 445 of a corresponding rack 410 configured with logical volume 160-B that holds object 550-A. In that case, a single compute instance may be linked to and may provide access to different objects. Correspondingly, a single compute instance may be linked to and may provide access to different volumes, in another example.

As also shown in FIG. 5D, a communication path 515 may link the compute instance 130-B to a data object 550-A located at the CVP 150. In some examples, the data object 550-A may be located within the volume 160-B. The communication path 515 shown linking the compute instance 130-B to the data object 550-A, such as through the volume 160-B, may include the CSP-2 router 432 at the CSP-2 (110″), the network 756, the data center router 420, the CSP-2 router 432′ located at the data center 400, the CVP router 440, and a corresponding switch 445 of a corresponding rack 410 configured with logical volume 160-B that holds object 550-A. In that case, a single data object 550-A may be linked to and may provide access to different compute instances on the same or different CSPs.

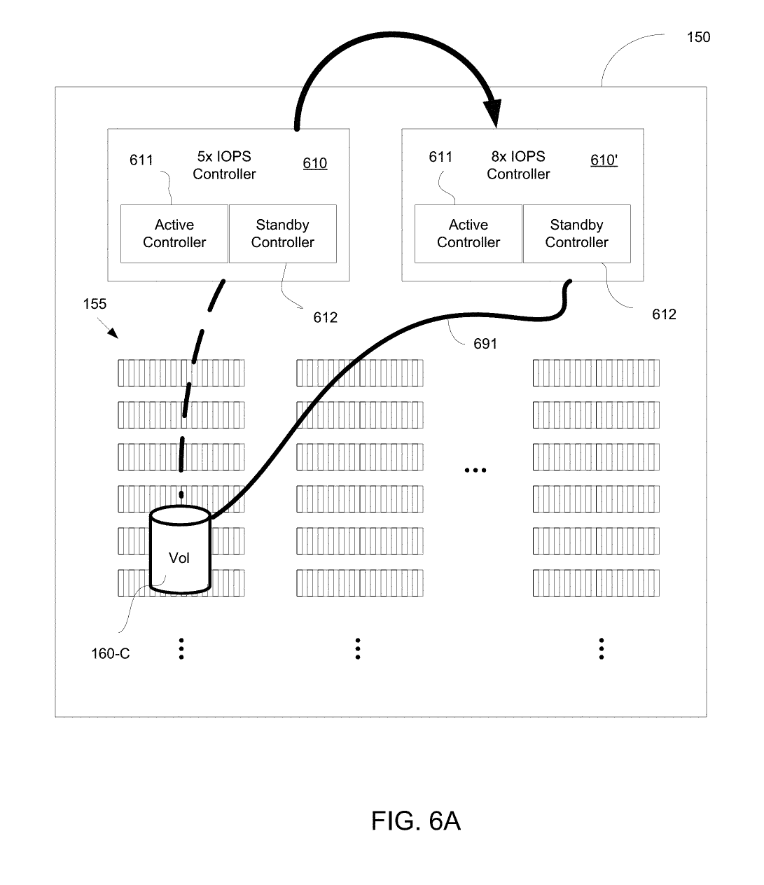

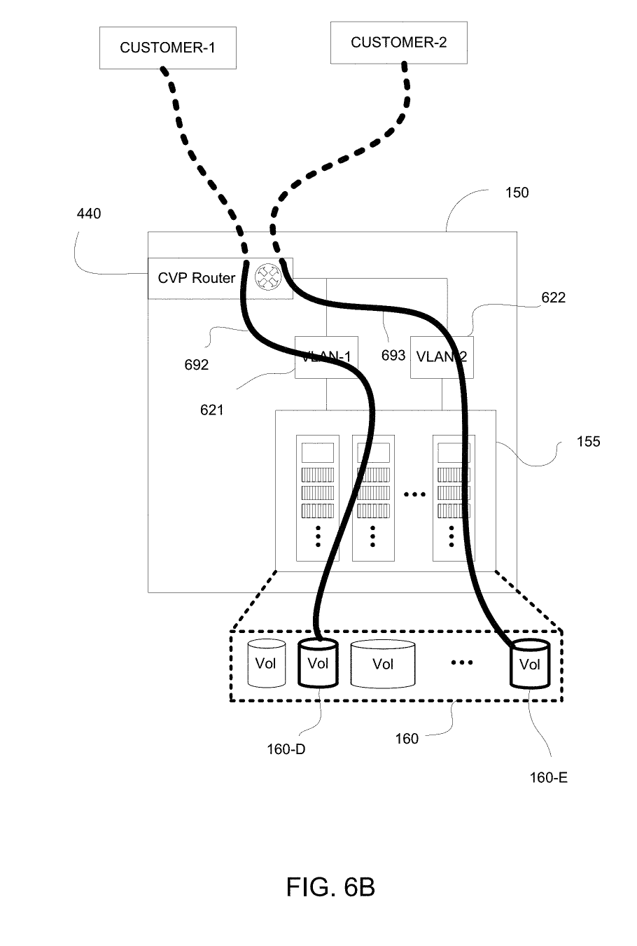

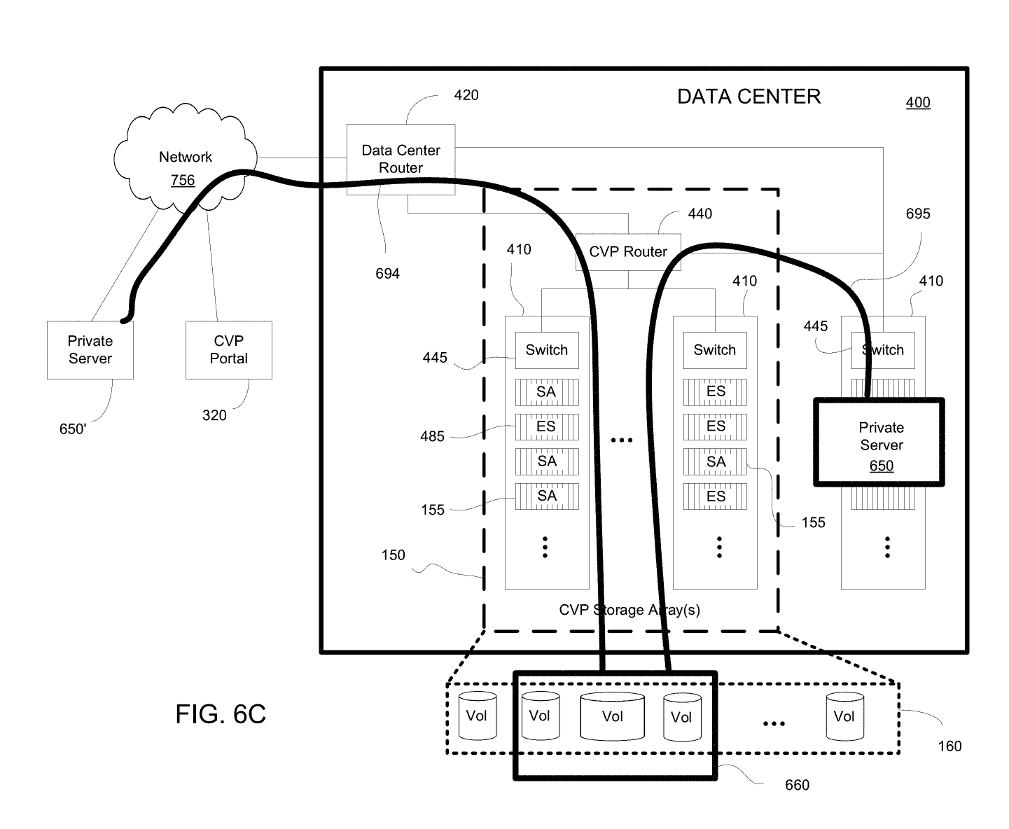

FIG. 6A illustrates an example cloud volume provider 150 offering configurable logical volumes of storage, in which a cloud compute instance of a cloud service provider may be linked to a specific volume within the storage arrays of the CVP 150, and in which the CVP 150 may access a specific volume using one or more controllers, each of which may be configured with different performance capabilities, in accordance with some examples. For example, each controller may operate in an active/standby configuration, and may include an active controller 611 that actively manages an underlying data storage system, and a standby controller 612 that tracks the activity within the data storage system such that the standby controller 612 may step in and replace the active controller 611 for purposes of periodic maintenance or during an unintended failure.

As shown, the one or more storage arrays of the CVP 150 may include a logical volume 160-C that is accessible to one or more controllers within the CVP 150. For example, at a first point in time, the volume 160-C may be initialized to be managed by 5× IOPS controller 610, having a middle of the road performance rating. For example, the 5× IOPS controller 610 may handle 5,000 IOs per second.

Because the volume 160-C is reconfigurable, a CVP portal 320 may reconfigure the volume 160-C to operate under a higher performance at a second point in time that is later than the first point in time. In that case, the volume 160-C May be accessed using an 8× IOPS controller 610′, thereby realizing an increased improvement in performance. For example, 8× IOPS controller 610′ may handle 8,000 IOs per second, instead of the 5,000 IOs per second handled previously.

FIG. 6B illustrates example communication paths between compute instances of a plurality of customers operating within one or more cloud service providers, in which communication paths within a data center are isolated between customers such that each customer is associated with its own virtual local area network (VLAN) used for accessing corresponding logical volumes of the corresponding customer. As shown, customer-1 operating a compute instance on a corresponding CSP is accessing a logical volume 160-D of a CVP 150 configured within a data center 400. The communication path 692 may include a CVP router 440 that is internal to the CVP 150. External communication paths to include corresponding CSP routers and networks are not shown for purposes of brevity and clarity. Internal to the CVP 150, the VLAN-1 network 621 may be used to facilitate internal communications within the CVP 150 for customer-1. As also shown, customer-2 operating a compute instance on a corresponding CSP is accessing a logical volume 160-E of CVP 150 within a data center 400. The communication path 693 may include the CVP router 440 that is internal to the CVP 150. External communication paths to include corresponding CSP routers and networks are not shown for purposes of brevity and clarity. Internal to the CVP 150, the VLAN-2 network 622 may be used to facilitate internal communications within the CVP 150 for customer-2. By operating over a different VLAN for each customer, data integrity may be maintained, and no cross-talk of data between customers may occur, even if the data is stored within the same CVP 150.

FIG. 6C illustrates an example cloud volume provider 150 offering cloud storage for use by a private server 650, thereby implementing a private storage and a private compute architecture. As shown, the data center 400 may include the CVP 150, as previously described, which may provide access to a plurality of volumes as supported by one or more storage arrays 155. The CVP 150 may provide private storage to a private server. That is, the CVP 150 may be dedicated to fully support private servers 650 or 650′, in one example. In other examples, the CVP 150 may support multiple clients but may partition out private storage for private servers 650 or 650′. For example, the private server 650 may be located within the data center 400, in one example. As such, the communication path 695 may provide a direct and internal path within the data center 400 to link compute instances operating within the private server 650 and corresponding volumes 660 within the plurality of volumes 160 possibly managed by the CVP 150. As previously described, the CVP portal 320 may provide linking between a compute instance and a logical volume. In another example, the private server 650′ may be located remotely to the data center 400. In that case, a communication path 694 may provide a networked path from the private server 650′ through network 756, through the data center router, and the CVP router 440 to access the corresponding volumes 660.

For purposes of completeness, the following discussion refers to attributes of a physical storage array, which may be utilized as a storage resource in the cloud infrastructure of the cloud service provider. In some examples, reference to NVRAM, in the context of the storage array 502, may include parallel operations performed by memory cache 220 of the storage application 106. Cache worthy data written to solid-state drives in the storage array, may resemble operations that may be performed when writing to the read cache 204 in a cloud storage system. Data written to the object storage 134 may parallel operations when data is written to the hard disk drives 532 in the storage array 502. Some of these operations performed by the storage application 106, in one example, may be parallel to (at least in part) operations that are processed by a cache accelerated sequential layout (CASL) algorithm described below. It should be understood, that the CASL algorithm described with reference to the storage array 502 may not be identical to the operations performed by the storage app 106, but certain ones of the concepts may be implemented, or replaced, or substituted for operations performed by the storage application 106. With the foregoing in mind, the following description is with reference to a storage array 502.

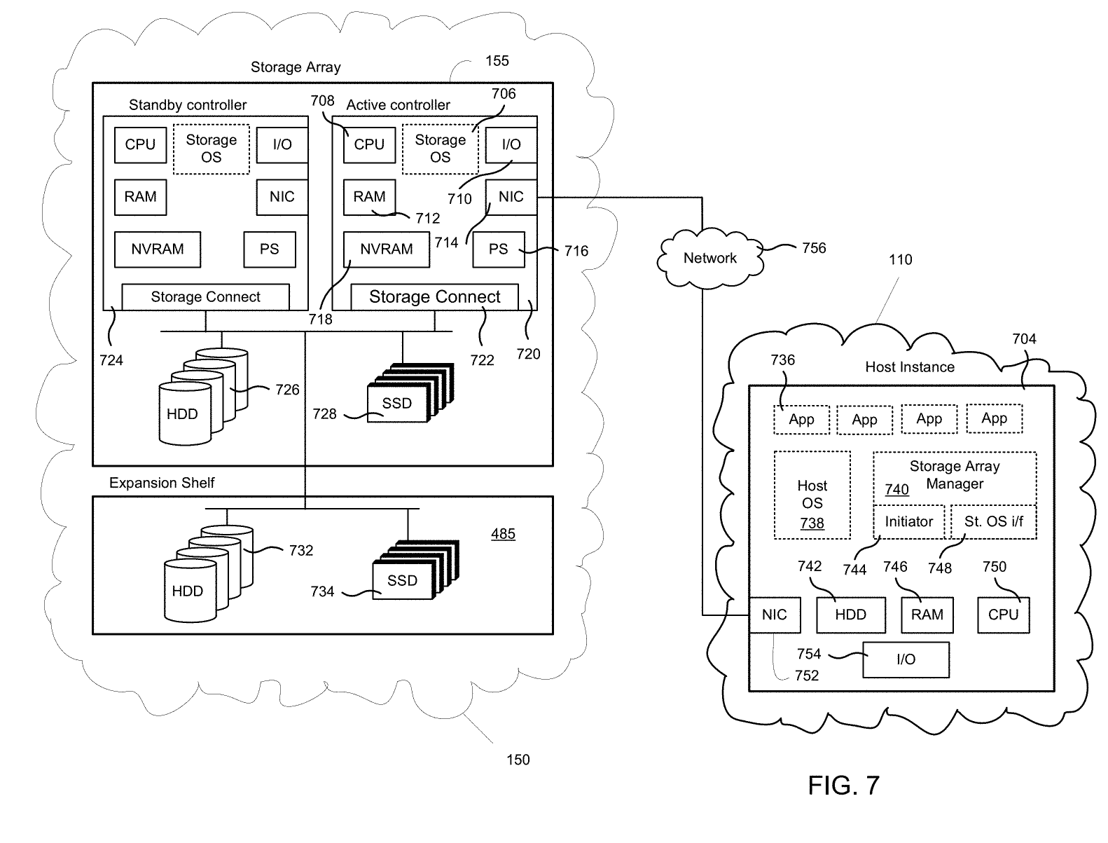

FIG. 7 illustrates an architecture of an example storage array 155 of a cloud volume provider in a data center. In one example, the storage array 155 may include an active controller 708, a standby controller 724, one or more HDDs 726, and one or more SSDs 728. In one example, the controller 720 includes non-volatile RAM (NVRAM) 718, which is for storing the incoming data as it arrives to the storage array. After the data is processed (e.g., compressed and organized in segments (e.g., coalesced)), the data is transferred from the NVRAM 718 to HDD 726, or to the SSD 728, or to both.

In addition, the active controller 720 may further include a CPU 708, a general-purpose RAM 712 (e.g., used by the programs executing in CPU 708), an input/output module 710 for communicating with external devices (e.g., USB port, terminal port, connectors, plugs, links, etc.), one or more network interface cards (NICs) 714 for exchanging data packages through the network 756, one or more power supplies 716, a temperature sensor (not shown), and a storage connect module 722 for sending and receiving data to and from the HDD 726 and SSD 728. In one example, the NICs 714 may be configured for Ethernet communication or Fibre Channel communication, depending on the hardware card used and the storage fabric. In other examples, the storage array 155 may operate using the iSCSI transport or the Fibre Channel transport.

The active controller 720 may execute one or more computer programs stored in the RAM 712. One of the computer programs may be the storage operating system (OS) used to perform operating system functions for the active controller device. In some implementations, one or more expansion shelves 485 may be coupled to the storage array 155 to increase HDD 732 capacity, or SSD 734 capacity, or both.

The active controller 720 and the standby controller 724 may have their own NVRAMs, but they may share HDDs 726 and SSDs 728. The standby controller 724 may receive copies of data that gets stored in the NVRAM 718 of the active controller 720 and may store the copies in its own NVRAM. If the active controller 720 fails, the standby controller 724 may take over the management of the storage array 155. When servers, also referred to herein as hosts, connect to the storage array 155, read/write requests (e.g., IO requests) may be sent over the network 756, and the storage array 155 may store the sent data or may send back the requested data to the host 704.

The host 704 may be a computing device including a CPU 750, memory (RAM) 746, permanent storage (HDD) 742, a NIC card 752, and an IO module 754. The host instance 704 may be operating within a CSP 110, as previously introduced. The host 704 may include one or more applications 736 executing on the CPU 750, a host operating system 738, and a computer program storage array manager 740 that may provide an interface for accessing storage array 155 to applications 736. The storage array manager 740 may include an initiator 744 and a storage OS interface program 748. When one of the applications 736 requests an IO operation, the initiator 744 may establish a connection with the storage array 155 in one of the supported formats (e.g., iSCSI, Fibre Channel, or any other protocol). The storage OS interface 748 may provide console capabilities for managing the storage array 155 by communicating with the active controller 720 and the storage OS 706 executing therein. It should be understood, however, that specific implementations may utilize different modules, different protocols, different number of controllers, etc., while still being to execute or process operations taught and disclosed herein.

In some examples, a plurality of storage arrays may be used in data center configurations or non-data center configurations. A data center may include a plurality of servers, a plurality of storage arrays, and combinations of servers and other storage. It should be understood that the exact configuration of the types of servers and storage arrays incorporated into specific implementations, enterprises, data centers, small office environments, business environments, and personal environments, may vary depending on the performance and storage needs of the configuration.

In some examples, servers may be virtualized utilizing virtualization techniques, such that operating systems may be mounted or operated using hypervisors to allow specific applications to share hardware and other resources. In virtualized environments, virtual hosts that provide services to the various applications and provide data and store data to storage may also access the storage. In such configurations, the storage arrays may service specific types of applications, and the storage functions may be optimized for the type of data being serviced.

For example, a variety of cloud-based applications may service specific types of information. Some information requires that storage access times are sufficiently fast to service mission-critical processing, while other types of applications are designed for longer-term storage, archiving, and more infrequent accesses. As such, a storage array may be configured and programmed for optimization that allows servicing of various types of applications. In some examples, certain applications may be assigned to respective volumes in a storage array. Each volume may then be optimized for the type of data that the volume will service.

As described with reference to FIG. 7, the storage array 155 may include one or more controllers 720, 724. One controller may serve as the active controller 720, while the other controller 724 may function as a backup controller (standby). For redundancy, if the active controller 720 were to fail, immediate transparent handoff of processing (i.e., fail-over) may be made to the standby controller 724. Each controller may therefore access storage, which in one example includes hard disk drives (HDD) 726 and solid-state drives (SSD) 728. As mentioned above, SSDs 728 may be utilized as a type of flash cache, which may enable efficient reading of data stored to the storage.

As used herein, SSDs functioning as “flash cache,” should be understood to operate the SSD as a cache for block level data access, providing service to read operations instead of only reading from HDDs 726. Thus, if data is present in SSDs 728, reading may occur from the SSDs instead of requiring a read to the HDDs 726, which may be a slower operation. As mentioned above, the storage operating system 706 may be configured with an algorithm that allows for intelligent writing of certain data to the SSDs 728 (e.g., cache-worthy data), and all data may be written directly to the HDDs 726 from NVRAM 718.

The algorithm, in one example, may select cache-worthy data for writing to the SSDs 728 in a manner that may provide an increased likelihood that a read operation will access data from the SSDs 728. In some examples, the algorithm may be referred to as a cache accelerated sequential layout (CASL) architecture, which may intelligently leverage unique properties of flash and disk to provide high performance and optimal use of capacity. In one example, CASL caches “hot” active data onto a SSD 728 in real time—without the need to set complex policies. This way, the storage array may instantly respond to read requests—as much as ten times faster than traditional bolt-on or tiered approaches to flash caching.

For purposes of discussion and understanding, reference is made to CASL as being an algorithm processed by the storage OS. However, it should be understood that optimizations, modifications, additions, and subtractions to versions of CASL may take place from time to time. As such, reference to CASL should be understood to represent an example functionality, and the functionality may change from time to time, and may be modified to include or exclude features referenced herein or incorporated by reference herein. Still further, it should be understood that the examples described herein are just examples, and many more examples and/or implementations may be defined by combining elements and/or omitting elements described with reference to the claimed features.

In some implementations, the SSDs 728 may be referred to as flash, or flash cache, or flash-based memory cache, or flash drives, storage flash, or simply cache. Consistent with the use of these terms, in the context of storage array 155, the various implementations of SSD 728 may provide block level caching to storage, as opposed to instruction level caching. As mentioned above, one functionality enabled by algorithms of the storage OS 706 is to provide storage of cache-worthy block level data to the SSDs 728, so that subsequent read operations may be optimized (i.e., reads that are likely to hit the flash cache will be stored to the SSDs 728, as a form of storage caching, to accelerate the performance of the storage array 155).

In one example, it should be understood that the “block level processing” of the SSDs 728, serving as storage cache, may be different than “instruction level processing,” which is a common function in microprocessor environments. In one example, microprocessor environments may utilize main memory, and various levels of cache memory (e.g., L1, L2, etc.). Instruction level caching may be differentiated further because instruction level caching is block-agnostic, meaning that instruction level caching may not be aware of what type of application is producing or requesting the data processed by the microprocessor. Generally speaking, the microprocessor may treat all instruction level caching equally, without discriminating or differentiating processing of different types of applications.

In the various implementations described herein, the storage caching facilitated by the SSDs 728 may be implemented by algorithms exercised by the storage OS 706, which may differentiate between the types of blocks being processed for each type of application or applications. That is, block data being written to storage (e.g., the SSDs 728 and/or the HDDs 726) may be associated with block data specific applications. For instance, one application may be a mail system application, while another application may be a financial database application, and yet another may be for a website-hosting application. Each application may have different storage accessing patterns and/or requirements. In accordance with several examples described herein, block data (e.g., associated with the specific applications) may be treated differently when processed by the algorithms executed by the storage OS 706, for efficient use of the flash cache 728.

Continuing with the example of FIG. 7, that active controller 720 is shown including various components that may enable efficient processing of storage block reads and writes. As mentioned above, the controller 720 may include an input output (10) 710, which may enable one or more machines to access functionality of the storage array 155. This access may provide direct access to the storage array, instead of accessing the storage array over a network. Direct access to the storage array may, in some examples, be utilized to run diagnostics implement settings, implement storage updates, change software configurations, and/or combinations thereof. As shown, the CPU 708 may communicate with the storage OS 706.

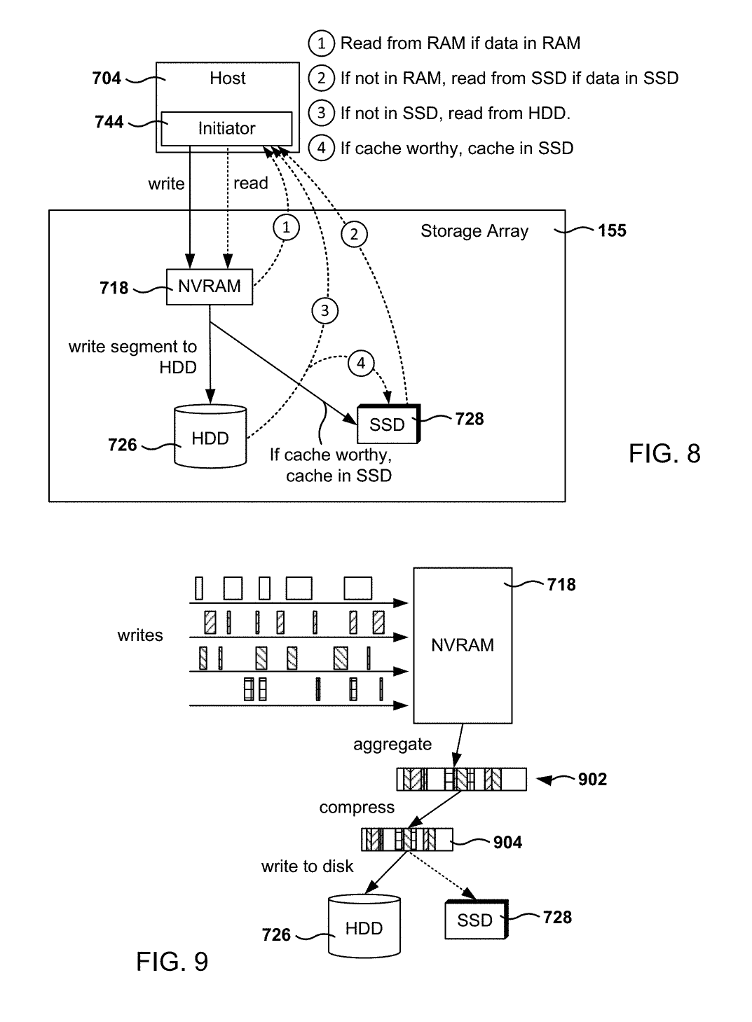

FIG. 8 illustrates read and write paths within the example storage array 155. Regarding the write path, the initiator 744 in the host 704 may send the write request to the storage array 155. As the write data comes in, the write data may be written into NVRAM 718, and an acknowledgment may be sent back to the initiator (e.g., the host or application making the request). In one example, the storage array 155 may support variable block sizes. Data blocks in the NVRAM 718 may be grouped together to form a segment that includes a plurality of data blocks, which may be of different sizes. The segment may be compressed and then written to the HDD 726. More details are provided below regarding the transfer of data from the NVRAM 718 to the HDD 726 with reference to FIG. 9. In addition, if the segment is considered to be cache-worthy (i.e., important enough to be cached or likely to be accessed again) the segment may also be written to the SSD cache 728. In one example, the segment may be written to the SSD 728 in parallel while writing the segment to the HDD 726.

In one example, the performance of the write path may be driven by the flushing of the NVRAM 718 to the disk 726. With regard to the read path, the initiator 744 may send a read request to the storage array 155. The requested data may be found in any of the different levels of storage mediums of the storage array 155. First, a check may be made to see if the data is found in RAM (not shown), which may be a shadow memory of the NVRAM 718, and if the data is found in RAM then the data may be read from RAM and sent back to the initiator 744. In one example, the shadow RAM memory (e.g., DRAM) may keep a copy of the data in the NVRAM 718 and the read operations may be served from the shadow RAM memory. When data is written to the NVRAM, the data may also be written to the shadow RAM so the read operations may be served from the shadow RAM leaving the NVRAM free for processing write operations.

If the data is not found in the shadow RAM, then a check may be made to determine if the data is in cache, and if so (i.e., cache hit), the data may be read from the flash cache 728 and sent to the initiator 744. If the data is not found in the NVRAM 718 nor in the flash cache 728, then the data may be read from the hard drives 726 and sent to the initiator 744. In addition, if the data being served from the hard disk 726 is cache worthy, then the data may also be cached in the SSD cache 728.

FIG. 9 illustrates example segmentation and compression of write data blocks before saving/writing to hard disk. The different blocks may arrive from one or more hosts to the storage array and then the blocks may be stored in the NVRAM 718. The incoming blocks may then be aggregated into a segment 902, by concatenating the receiving blocks as they arrive to the NVRAM 718. It should be noted that the blocks may have different sizes in one example. The segment 902 may be compressed 904 before transmittal to the disk, which may result in time savings for the transmittal and savings in the space utilized in the hard drives 926. As noted above, if the data is cache-worthy, then the data may also be written to the flash cache 928. This architecture may be very efficient for random writes, as the data is not sorted before being sent to the hard drives, as it is often done in other storage architectures. Here, the data is fluently captured, segmented, compressed, and then sent to the drives, which may result in a fast write path for the incoming data.

FIG. 10 illustrates an example volume storage system (e.g., cloud volume provider) which may utilize cloud storage to enable third party storage solutions for compute instances running on cloud service providers, and the use of data analytics to provide predictive information useful to entities operating the compute instances as provided by a cloud storage management system 1000. As mentioned above, the CVP may include a plurality of storage arrays configured as a plurality of logical volumes. A set of logical volumes may be associated with a particular entity. Access to each storage array may be performed via a corresponding controller (e.g., operating in an active standby configuration), in which a storage operating system 706 on the controller may provide access to storage in the CVP 150. In addition, the storage operating system 706 is configurable for communicating metadata regarding the storage handling with another process executing cloud storage management.

In one example, the cloud storage management system 1000 may execute a management portal 1020 which provides access over the Internet, or local area networks (LAN), or wide area networks (WAN), and combinations thereof. For example, management portal 1020 may be the InfoSight services 330 first introduced in FIG. 3C.

As shown, example compute instances 130 (e.g., hosts) and servers may be in communication with the network 756 (e.g., the Internet) and may provide services to a plurality of clients. As noted above, the clients may access the network 756 to utilize applications, services, processing, content, and share information and data. The data being accessed and shared or processed may be stored in a plurality of storage arrays 155 operating within the CVP storage system 150. Management of the data from the cloud storage system 150 may be provided by collecting metadata from the storage operating systems 706 when they are serving storage needs for one or more applications. Over time, the storage processing may act to collect metadata that is useful to identify trends, storage needs, capacity requirements, and usage of different types of storage resources, e.g., block storage, object storage, or even long term storage. In some cases, this metadata may be analyzed to find trends, project needs, or even instruct a change in the way storage resources are used.

In still other examples, the metadata may be used to generate recommendations to users of the application, which may optimize the way storage resources are used in the cloud infrastructure. In other examples, the received metadata may be used to make dynamic changes to provisioned storage resources. For instance, if less block storage is used than what was initially provisioned, the amount of block storage reserved or paid for by the customer executing application 108 may be adjusted. This may provide for further costs savings, as adjustments may be made dynamically and in some examples, continuously, to provide fine grain changes and modifications. In addition, the metadata may be used to determine when a logical volume will run out of storage space, and to make a recommendation to increase the size of the logical volume before that predicted time.

Further, the metadata may be used to peer into the performance characteristics of external cloud service providers. Normally, performance values of CSPs are difficult to obtain as the CSP prevents a view into the internal operations. According to examples, data storage performance may be analyzed to infer performance at one or more CSPs. For example, when two different compute instances executing on different CSPs are configured identically (e.g., running the same application), and access data on one or more logical volumes that may also similarly be configured at the CVP, the way the data is serviced at the CVP may provide an insight as to how each CSP is performing. For example, if a first compute instance at a first CSP is able to access data at a higher rate than a second compute instance at a second CSP, then when assuming similar configurations at both the CSP and CVP, it may be determined that the first CSP is performing better than the second CSP. Over time, great insight may be achieved as to the operations of one or more CSPs.

In some examples, in addition to receiving metadata from storage applications, metadata may also be received from the storage arrays 155. These storage arrays 155 may be installed in the CVP 150 (e.g., commercial data center). In some examples, customers that use the supported storage arrays 155 may be provided with access to the management portal 1020. For example, the storage arrays 155 may connect to a network 756, and in turn may share information with a cloud storage management system 1000. The cloud storage management system 1000 may execute a plurality of functions and algorithms to facilitate management of the storage arrays 155, which may be deployed in various configurations, locations, datacenters, implementations, and other constructs.

In some examples, the storage operating system 706 may be used to service real-time data delivery to various applications over the network 756, such as on-demand applications, gaming systems, websites, streaming networks, video content delivery systems, audio content delivery systems, database information, business metrics, remote desktop applications, virtualized network infrastructures, and other storage related functions and/or internet and website related processing. All of this processing may generate unique types of traffic flows and unique demands on a cloud storage infrastructure. As such, the storage operating system 706 is well suited in the write and read data path, to track storage usage metrics. These metrics are broadly referred to as metadata, which the cloud storage management may collect. As mentioned above, the cloud storage management may be operating on a different machine, in the same cloud infrastructure, or a different cloud infrastructure. The metadata, no matter where collected and processed, may be used to generate the aforementioned recommendations and/or dynamic changes to the usage of the storage (i.e., usage of block storage and usage of object storage, in the context of a CVP 150).

In some implementations, the cloud storage management 1000 may include and process various modules to assist in efficient management of the CVP 150. Without limitation, the following are certain types of processing algorithms and methods that the cloud storage management system 1000 may execute based on metadata received. These examples may include analytics processing to determine usage of storage, similarities in usage of storage by different applications, performance of applications based on certain configuration sets, and other modifications and analytics associated therewith. Still further, the cloud storage management system 1000 may also include logic for processing learning algorithms.

The learning algorithms may be utilized to determine when certain configurations of storage should be implemented, based on previous settings and/or changes made by the same implementer of the storage application or by looking for similarities and changes made or settings made by other storage application implementers or users. Algorithms may also be used to predict when certain settings should be changed. These predictions may be ranked based on the success of certain changes over time, and based on the success experienced by such specific changes.

In another example, the cloud storage management system 1000 may also perform capacity testing, and this testing may occur based on the demands being made on the storage, the types of applications being run, and the stress that the CVP 150 has been placed under. The cloud storage management system may also dynamically review system configurations so as to determine whether the right consistent configurations have been set, and/or provide recommendations for changes. Additional performance and health testing algorithms may also be run by querying and sending data, commands, analytics requests and other logic and data to and from the storage operating system 706. In one example, recommendations may be sent to administrators of executing applications and/or users of the storage arrays 155, who may determine whether to implement or not implement certain recommendations and/or settings. In other examples, certain upgrades, changes, modifications and/or the like, may be implemented based on predefined settings, authorizations, or implicit settings and/or authorizations by a user, IT manager, storage manager, data center manager, or other authorized storage management personnel. Still further, the cloud storage management system 1000 may also manage historical changes made, and determine when changes have been successful or have reduced the performance and/or goal desired by the implementing individual.

By analyzing historical changes and/or data from various CVPs 150, it may be possible to identify optimizations at cross points or intersections of efficiencies, and such data may be used to provide recommendations for improved optimizations. The system may also include scheduling algorithms which may be used to automatically communicate with the storage operating system 706, collect data, run additional applications or routines, run logic, collect data, send optimizations, make recommendations, and/or adjust settings. In some examples, the management portal may also access support data, which may be optimized for specific user accounts. For example, some analytics, data processing, optimizations, what if testing, recommender logic, and other functions may be limited to specific accounts, based on their level of service desired. In some examples, higher levels of service or support may be given higher levels of feedback by the cloud storage management system 1000.

Broadly speaking, the functionality of the various algorithms managed by the cloud storage management system 1000 may be used to provide specific functionality. Example functionality may include monitoring and reporting functions 1010, maintenance and support functions 1012, alerting functions 1014, peer insights 1016, and forecasting and planning 1018. These various functions may take and use logic described above and defined within the inner diagram of the cloud storage management system 1000. In various examples, the portal management may provide access to the plurality of user interface screens with selection boxes, setting boxes, metrics analysis, diagrams, charts, historical data, alerts, recommendations, and other user interface and/or command-line data. In other examples, changes to the storage array 155 cloud configurations within the CVP 150 may be made, e.g., by changing configuration data.

In one example, the storage lifecycle data (e.g., historical data, metadata, etc.) may be leveraged to enable deep analysis of data regarding a storage application. This analysis may enable the automation and integration of data mining from storage application usage and functionality to automate and simplify storage administrative tasks. For instance, through analysis of metadata across various storage operating systems 706, it may be possible to predict when configuration issues may arise for particular customer configurations. In some examples, this information may be used to determine when upgrades from one configuration (e.g., software and/or hardware) are recommended or when certain upgrades should be avoided. In one example, having access to metadata of other applications and/or other CVPs 150 (e.g., across many disparate installations) may allow for efficient diagnosis of current issues, potential issues or recommendations to ensure optimal health of particular cloud implementations of the CVPs 150.

It should be apparent, that the features of the present disclosure may be practiced without some or all of these specific details. Modification to the modules, code and communication interfaces are also possible, so long as the defined functionality for the storage array or modules of the storage array is maintained. In other instances, well-known process operations have not been described in detail in order not to unnecessarily obscure the present examples.

One or more examples disclosed herein may also be fabricated as computer readable code on a non-transitory computer readable storage medium. The non-transitory computer readable storage medium may be any non-transitory data storage device that may store data, which may thereafter be read by a computer system. Examples of the non-transitory computer readable storage media include hard drives, network attached storage (NAS), read-only memory, random-access memory, CD-ROMs, CD-Rs, CD-RWs, magnetic tapes and other optical and non-optical data storage devices. The non-transitory computer readable storage medium may include computer readable storage medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing examples have been described in some detail for purposes of clarity of understanding, it will be apparent that certain changes and modifications may be practiced within the scope of the appended claims. Accordingly, the present examples may be considered as illustrative and not restrictive, and the examples are not to be limited to the details given herein, but may be modified within the scope and equivalents of the described examples and sample appended claims.

What is claimed is:

1. A data storage system comprising:
a plurality of storage arrays of a cloud volume provider (CVP), wherein the plurality of storage arrays is a plurality of logical volumes; and
a CVP portal to link a first compute instance of a first cloud service provider (CSP) with a first logical volume over a network, wherein a first application executing on the first compute instance is to access the first logical volume for storage, wherein the first CSP provides at least one compute instance for a corresponding entity.

2. The data storage system of claim 1, wherein the CVP portal is to initialize the first logical volume with a user defined performance configuration, a user defined size, and the first compute instance.

3. The data storage system of claim 1, further comprising:
wherein the CVP portal is to link a second compute instance of a second CSP with the first logical volume, wherein a second application executing on the second compute instance accesses the first logical volume for storage, and
wherein the second CSP provides at least one compute instance for a corresponding entity.

4. The data storage system of claim 3, wherein the second application is the first application.

5. The data storage system of claim 1, wherein the CVP portal is to link a second compute instance of a second CSP with a second logical volume at the CVP, wherein a second application executing on the second compute instance accesses the second logical volume for storage, and wherein the second CSP provides at least one compute instance for a corresponding entity.

6. The data storage system of claim 5, wherein the second application is the first application.

7. The data storage system of claim 1, wherein the CVP portal is to link a second compute instance of the first CSP with the first logical volume, wherein a second application executing on the second compute instance accesses the first logical volume for storage.

8. The data storage system of claim 1, further comprising:
a data center to provide resources and support to the plurality of storage arrays;
a data center router to facilitate communication over an external network;
a first CSP router in the data center, the first CSP router to receive communications from the first CSP via the data center router; and
a CVP router in the CVP,
wherein the first CSP router and the CVP router are within a communication path between the first compute instance of the first CSP and the first logical volume.

9. The data storage system of claim 1, further comprising:
a data center to provide resources and to support the plurality of storage arrays;
a first virtual local area network (VLAN) providing communications to a first plurality of logical volumes that is associated with a first entity, wherein the first VLAN isolates communications with the first plurality of logical volumes from communications with other logical volumes; and
a second VLAN providing communications to a second plurality of logical volumes that is associated with a second entity, wherein the second VLAN isolates communications with the second plurality of logical volumes from communications with other logical volumes.

10. A method comprising:
generating instructions for initializing a first logical volume of storage within a cloud volume provider (CVP) comprising a plurality of storage arrays configured as a plurality of logical volumes; and
generating instructions for linking a first compute instance at a first cloud service provider (CSP) with the first logical volume, wherein the first CSP is to provide at least one compute instance of a corresponding entity, and wherein a first application executing on the first compute instance accesses the first logical volume for storage.

11. The method of claim 10, wherein generating instructions for initializing comprises:
generating instructions for configuring the first logical volume with a user defined first size; and
generating instructions for configuring the first logical volume with a user defined performance level of service.

12. The method of claim 11, further comprising:
generating instructions for reconfiguring the first logical volume to a second size.

13. The method of claim 10, wherein generating instructions for linking the first compute instance with the first logical volume further comprises:
generating instructions for defining a communication path between the first compute instance at the first CSP and the first logical volume at the CVP.

14. The method of claim 13, wherein the communication path includes a data center router to facilitate communication over a network external to a data center, wherein the data center is to support the CVP,
wherein the communication path includes a first CSP router in the data center and to receive communications from the first CSP via the data center router; and
wherein the communication path includes a CVP router in the CVP.

15. The method of claim 10, further comprising:
establishing a first virtual local area network (VLAN) providing communications to a first plurality of logical volumes in the CVP that is associated with a first entity, wherein the first VLAN isolates communications with the first plurality of logical volumes from communications with other logical volumes; and
establishing a second VLAN providing communications to a second plurality of logical volumes in the CVP that is associated with a second entity, wherein the second VLAN isolates communications with the second plurality of logical volumes from communications with other logical volumes.

16. The method of claim 10, further comprising:
generating instructions for linking a second compute instance at a second CSP with the first logical volume, wherein a second application executing on the second compute instance accesses the first logical volume for storage.

17. The method of claim 10, further comprising:
generating instructions for linking a second compute instance at a second CSP with a second logical volume, wherein a second application executing on the second compute instance accesses the second logical volume for storage.

18. The method of claim 10, further comprising:
generating instructions for linking a second compute instance at the first CSP with the first logical volume, wherein a second application executing on the second compute instance accesses the first logical volume for storage.

19. A non-transitory computer-readable medium on which is stored computer readable instructions that when executed by a processor, cause the processor to:
initialize a first logical volume of storage within a cloud volume provider (CVP) comprising a plurality of storage arrays configured as a plurality of logical volumes; and
link a first compute instance at a first cloud service provider (CSP) with the first logical volume,
wherein the first CSP is to provide at least one compute instance of a corresponding entity, and
wherein a first application executing on the first compute instance accesses the first logical volume for storage.

20. The non-transitory computer-readable medium of claim 19, wherein the CVP portal is to initialize the first logical volume with a user defined performance configuration, a user defined size, and the first compute instance.
